(19) United States
(12) Patent Application Publication
(10) Pub. No.: US 2024/0230358 A1
(43) Pub. Date: Jul. 11, 2024

(54) Flexible Navigation and Route Generation

(71) Applicant: Google LLC, Mountain View, CA (US)

(72) Inventors: Matthew Sharifi, Kilchberg (CH); Victor Carbune, Zurich (CH)

(21) Appl. No.: 17/928,398

(22) PCT Filed: Jul. 20, 2021
(86) PCT No.: PCT/US2021/042304

§ 371 Date: Nov. 29, 2022

(51) Int. Cl. G01C 21/36; G01C 21/34

(52) U.S. Cl. CPC G01C 21/3617; G01C 21/3446; G01C 21/3492; G01C 21/3632; G01C 21/3694

(57) ABSTRACT

Methods, systems, devices, and tangible non-transitory computer readable media for navigation are provided. The disclosed technology can include accessing navigation data that includes information associated with a navigation request from a user. Based on the navigation data, a determination of whether the navigation request indicates a specific location or a deferred travel time can be made. Based on the navigation request, one or more locations and one or more travel times associated with fulfilling the navigation request can be determined. The one or more locations can be based on whether the navigation request indicates a specific location. The one or more travel times can be based on whether the navigation request indicates a deferred travel time. Furthermore, output including a time window of the one or more travel times for the user to travel to at least one of the one or more locations can be generated.

### FIELD

The present disclosure relates generally to the generation of routes and route directions for navigation. More particularly, the present disclosure relates to generating flexible routes and directions based on user navigation requests.

### BACKGROUND

Operations associated with the state of a geographic area can be implemented on a variety of computing devices. These operations can include processing data associated with requests by a user for assistance in navigating the geographic area. Further, the operations can include exchanging data with remote computing systems that may provide the state of the geographic areas being navigated. However, the navigational directions provided by such computing devices do not determine the benefits of deferring travel to a later time or travelling to a location that can serve as a substitute for the location indicated in the requests. Accordingly, there may exist a demand for a way to provide navigational directions and other navigational information that can reduce the duration of travel or distance traveled by a user.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of navigation. The computer-implemented method can include accessing, by a computing system comprising one or more processors, navigation data that can include information associated with a navigation request from a user. The computer-implemented method can include determining, by the computing system, based at least in part on the navigation data, whether the navigation request indicates a specific location. The computer-implemented method can include determining, by the computing system, based at least in part on the navigation data, whether the navigation request indicates a deferred travel time. The computer-implemented method can include determining, by the computing system, based at least in part on the navigation data, one or more locations and one or more travel times associated with fulfilling the navigation request. The one or more locations can be determined based at least in part on whether the navigation request indicates a specific location. The one or more travel times can be determined based at least in part on whether the navigation request indicates a deferred travel time. Furthermore, the computer-implemented method can include generating, by the computing system, output comprising one or more indications associated with navigation by the user to at least one of the one or more locations during a time window comprising at least one of the one or more travel times.

Another example aspect of the present disclosure is directed to one or more tangible non-transitory computer-readable media storing computer-readable instructions that when executed by one or more processors cause the one or more processors to perform operations. The operations can include accessing navigation data that can include information associated with a navigation request from a user. The operations can include determining, based at least in part on the navigation data, whether the navigation request indicates a specific location. The operations can include determining, based at least in part on the navigation data, whether the navigation request indicates a deferred travel time. The operations can include determining, based at least in part on the navigation data, one or more locations and one or more travel times associated with fulfilling the navigation request. The one or more locations can be determined based at least in part on whether the navigation request indicates a specific location. The one or more travel times can be determined based at least in part on whether the navigation request indicates a deferred travel time. Furthermore, the operations can include generating output comprising one or more indications associated with navigation by the user to at least one of the one or more locations during a time window comprising at least one of the one or more travel times.

Another example aspect of the present disclosure is directed to a computing system comprising: one or more processors; one or more non-transitory computer-readable media storing instructions that when executed by the one or more processors cause the one or more processors to perform operations. The operations can include accessing navigation data that can include information associated with a navigation request from a user. The operations can include determining, based at least in part on the navigation data, whether the navigation request indicates a specific location. The operations can include determining, based at least in part on the navigation data, whether the navigation request indicates a deferred travel time. The operations can include determining, based at least in part on the navigation data, one or more locations and one or more travel times associated with fulfilling the navigation request. The one or more locations can be determined based at least in part on whether the navigation request indicates a specific location. The one or more travel times can be determined based at least in part on whether the navigation request indicates a deferred travel time. Furthermore, the operations can include generating output comprising one or more indications associated with navigation by the user to at least one of the one or more locations during a time window comprising at least one of the one or more travel times.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example of a computing system that performs operations associated with flexible navigation according to example embodiments of the present disclosure.

FIG. 1B depicts a block diagram of an example of a computing device that performs operations associated with flexible navigation according to example embodiments of the present disclosure.

FIG. 1C depicts a block diagram of an example of a computing device that performs operations associated with flexible navigation according to example embodiments of the present disclosure.

FIG. 2 depicts a block diagram of an example of one or more machine-learned models according to example embodiments of the present disclosure.

FIG. 3 depicts an example of a user computing device according to example embodiments of the present disclosure.

FIG. 4 depicts an example of a navigation system according to example embodiments of the present disclosure.

FIG. 5 depicts an example of a navigation system according to example embodiments of the present disclosure.

FIG. 6 depicts an example of a navigation system according to example embodiments of the present disclosure.

FIG. 7 depicts an example of a navigation system according to example embodiments of the present disclosure.

FIG. 8 depicts a flow diagram of flexible navigation according to example embodiments of the present disclosure.

FIG. 9 depicts a flow diagram of flexible navigation according to example embodiments of the present disclosure.

FIG. 10 depicts a flow diagram of flexible navigation according to example embodiments of the present disclosure.

FIG. 11 depicts a flow diagram of flexible navigation according to example embodiments of the present disclosure.

FIG. 12 depicts a flow diagram of flexible navigation according to example embodiments of the present disclosure.

FIG. 13 depicts a flow diagram of flexible navigation according to example embodiments of the present disclosure.

FIG. 14 depicts a flow diagram of flexible navigation according to example embodiments of the present disclosure.

Reference numerals that are repeated across plural figures are intended to identify the same features in various implementations.

### DETAILED DESCRIPTION

Example aspects of the present disclosure are directed to a computing system that can generate indications for flexible navigation based on a user's navigation request. In particular, the disclosed technology can generate navigation indications based on the specificity of the location or travel time that are indicated in the content of a user's navigation request. Further, the disclosed technology can leverage the use of machine-learned models that can use natural language processing techniques to extract useful semantic and contextual information from navigation requests in order to provide improved and more flexible navigation options for a user.

For example, a user can use a navigation application to generate a navigation request (e.g., a search term entered provided to the navigation application) associated with a route to a location the user wishes to visit. The navigation request may include an indication of the time at which the user would like travel to the location (e.g., the user can indicate “I need to visit the grocery store this afternoon.”). A computing system of the disclosed technology can then parse the navigation request and determine that the navigation request includes a location (e.g., the grocery store) and a deferred travel time to visit the grocery store (e.g., the afternoon). Further, the computing system can determine that the location is not specific (e.g., the user did not specify a particular grocery store location or a particular grocery store chain). The computing device can then generate a time window (e.g., from one (1) o'clock in the afternoon to three (3) o'clock in the afternoon) and a set of grocery store locations that the user can visit during the time window.

As such, the disclosed technology allows for improved navigation by determining the semantic content of the user's navigation request and in particular whether a specific location and/or a deferred travel time were indicated by the user. Furthermore, the disclosed technology allows the user to navigate to locations more efficiently by providing flexible navigation indications that allow the user to defer navigation so that travel duration is shortened or the user can travel to alternative (substitute) locations that are closer to the user. The disclosed technology therefore processes navigation requests in a way that can lead to a reduction in travel time and/or travel distance, thereby reducing traffic congestion, energy usage, and vehicle emissions.

By way of example, the disclosed technology can use one or more devices operated by a user (e.g., a user operating a navigation device such as a smartphone, an in-vehicle computing system, and/or in-vehicle navigation system) to access the user's navigation request and use some combination of machine-learned models and/or heuristics to determine whether the navigation request indicated a specific location and/or a deferred travel time. Further, the disclosed technology can determine alternative locations for the user when a specific location was not indicated in the navigation request. For example, the computing system can provide flexible navigation indications via an audio system of a vehicle the user is in. In response to receiving the flexible navigation indications, the user can instruct the computing system to perform operations based on the flexible navigation indications. For example, based on the flexible navigation indications, the user can defer navigation to a more propitious time when traffic is lighter and travel times are shorter. As such, the disclosed technology facilitates a user's interaction with a navigation system by providing flexibility with respect to when and where the user should navigate to reduce travel duration and/or travel distance.

Furthermore, in response to a user's tactile feedback, gestural feedback, and/or spoken feedback, as well as a user's availability as determined using event data associated with a user's calendar and schedule, the disclosed technology can improve its performance by using the user feedback as an input for a machine-learned model that can use the feedback as training input. In this way, the disclosed technology can, over time, and through the user's interactions, be more finely tuned to the preferences of each individual user. Furthermore, in some embodiments, the disclosed technology can be customizable so that users can configure the disclosed technology to suit their particular preferences. The disclosed technology can include options that a user can use to select global preferences including a preference to optimize the flexible navigation indications to focus on one or more constraints. In particular, the disclosed technology can be configured to optimize for travel time, travel distance, an amount of traffic, or some combination of factors including travel time, travel distance, and/or an amount of traffic.

For example, the user can configure the disclosed technology to optimize the navigation indications for a lower travel time and will provide output that includes one or more indications associated with navigating to a destination in the lowest amount of time and/or in an amount of time that is below some travel time threshold. By way of further example, the disclosed technology can be configured to optimize the navigation indications to be based at least in part on a shorter travel distance and will provide output that includes one or more indications associated with navigating to a destination in the shortest distance and/or in a distance that is below some travel distance threshold. Furthermore, the user can configure the disclosed technology to optimize the navigation indications to be based at least in part on a combination of travel time, travel distance, and/or traffic and will provide output that includes one or more indications associated with navigating to a destination based on a combination of travel time, travel distance, and/or an amount of traffic that satisfies a respective set of travel time thresholds, travel distance thresholds, and/or traffic thresholds.

Accordingly, the disclosed technology can improve the user experience by providing the user with flexible navigation indications that include a time window and during which the user can travel to one or more locations which can include alternative locations when a specific location was not indicated. Further, the disclosed technology can assist a user in more effectively and/or safely performing the technical task of navigation from one location to another by means of a continued and/or guided human-machine interaction process in which the disclosed technology generates navigation indications based on navigation requests from a user.

The disclosed technology can be implemented in a computing system (e.g., a navigation computing system) that is configured to access data, perform operations on the data (e.g., determine whether a request from a user indicates a specific location and/or a deferred travel time), and generate output including indications of a time window and at least one location for navigation that may be directed to the user of the computing system. Further, the computing system can leverage one or more machine-learned models that have been configured to generate a variety of output including indications of a time when travel duration will be shortest and/or alternative locations a user may visit to fulfill their navigation request. The computing system can be included in a vehicle (e.g., an in-vehicle navigation system) and/or as part of a system that includes a server computing device that receives data associated with a request from the user that includes a starting location (e.g., a user's current location) and a destination from a user's client computing device (e.g., a smart phone), performs operations based on the data and sends output including flexible navigation options (e.g., time windows to travel and/or alternative destinations) back to the client computing device. The client computing device can, for example, be configured to announce available travel times to a user and receive user feedback in response to the provided travel times.

The computing system can access, receive, obtain, and/or retrieve navigation data. The navigation data can include information associated with a navigation request from a user. The navigation data can include information associated with a current location of a computing device and/or one or more locations that were previously travelled to by the computing device. For example, the navigation data can include a latitude, longitude, and/or altitude associated with one or more locations including the current location and/or a travel destination. Further, the navigation data can include information associated with one or more maps of a geographic area that include the current location, a starting location (e.g., a starting location that is different from the current location), and/or the travel destination. For example, the navigation data can include a map of a city that includes one or more locations of one or more roads (e.g., streets, highways, cycle paths, and/or foot paths), bodies of water (e.g., lakes, rivers, and/or ponds), waterways (e.g., canals), buildings (e.g., office buildings, residential buildings, and/or houses), bridges, tunnels, overpasses, and/or underpasses. Further, the navigation data can include information associated with traffic including a volume of traffic at one or more locations during different times of the day, traffic regulations (e.g., speed limits in a geographic region and where parking a vehicle is permissible), and/or traffic flow patterns (e.g., the direction and/or amount of pedestrian and/or vehicular traffic in a geographic area). The navigation data can include information associated with the state of a geographic area and can be based at least in part on real-time and/or near real-time (e.g., a five (5) second delay or a thirty (30) second delay) information from one or more sensors and/or reports of activity in the geographic area.

Further, the navigation data can include information associated with one or more addresses and/or one or more tagged locations (e.g., locations that have been tagged by a user or other individuals) that are within the geographic area. For example, the one or more addresses and/or one or more tagged locations can include a user's office location, a user's home address, one or more restaurants that have been frequented by the user or a user's associates (e.g., family and/or friends), one or more stores (e.g., grocery stores, pharmacies, and/or shopping centers) that have been frequented by the user or a user's associates, and/or one or more schools (e.g., elementary schools, secondary schools, and/or post-secondary schools including universities) that are attended by the user or the user's associates.

The navigation request can be based at least in part on one or more inputs from a user including one or more tactile inputs (e.g., a user touching the graphical user interface that is displayed on the touchscreen display of a computing device), one or more audible inputs (e.g., the use saying the location to travel to and a preferred travel time), one or more visual inputs (e.g., the user nodding their head in agreement with a provided time window and travel destination). Further, the navigation request can include one or more words and/or one or more characters that are provided by the user to indicate a location and/or travel time. For example, the disclosed technology can include a computing device that operates one or more navigation applications, one or more map applications, and/or one or more search applications, that can be used to input the navigation request of a user.

The computing system can determine whether the navigation request indicates, includes, and/or is associated with a specific location and/or a time. The time can include a date (e.g., a year, a month, and/or a day of the month), and/or a time of day (e.g., a clock time including one or more hours, one or more minutes, one or more seconds, and/or one or more tenths of seconds). For example, the time two thirty-five in the afternoon can be expressed as 2:35 p.m. or 14:35. By way of further example, the date February fifth in the year two-thousand and twenty-one can be expressed in a YYYY-MM-DD format as 2021-02-05. Further, the time can include a travel time. For example, the travel time can include that is indicated and/or included in the navigation request. Further, the travel time can include any time associated with a location (e.g., a destination), travelling, navigation, and/or transportation. Further, the travel time can include a deferred travel time (e.g., any time in the future which can include any time after the navigation request is made), an immediate travel time (e.g., a time in the present, a current time, a time when the navigation request was made, and/or a time within a predetermined duration of the time when the navigation request was made). The determination of whether the navigation request indicates a specific location and/or a deferred travel time can be based at least in part on the navigation data. In some embodiments, any of the terms including “future travel time,” “later travel time,” and/or “upcoming travel time” can be used interchangeably or in place of the term “deferred travel time.”

In some embodiments, the computing system can determine, based at least in part on the navigation data, whether the navigation request indicates one or more specific locations (e.g., a specific location). A specific location can include a location that is clearly defined, a location that is clearly identified, and/or a location that is clearly specified. In some embodiments, a specific location can include a unique location (e.g., a user's only home and/or a user's sole place of work or place of business) and/or a location that is associated with specific information and/or details including an address; latitude, longitude, and/or altitude; a business name (e.g., the name of a store, restaurant, refueling station, and/or club); and/or a street intersection.

In some embodiments, the computing system can determine, based at least in part on the navigation data, whether the navigation request indicates one or more deferred travel times (e.g., a deferred travel time). The one or more deferred travel times can include a travel time that is later than the current time (e.g., later by greater than some predetermined threshold duration of time such as at least fifteen (15) minutes later than the current time). Further, the one or more deferred travel times can include any time in the future (e.g., not the present time) and can be associated with any combination of a specific time in the future (e.g., four (4) o'clock this afternoon) and/or a relative time in the future (e.g., an hour from now or after school ends for the day).

In some embodiments, the one or more travel times and/or the one or more deferred travel times can include a specific travel time that is clearly defined and/or a specific travel time that is clearly identified. In some embodiments, the one or more travel times and/or the one or more deferred travel times can include a departure time (e.g., nine-thirty a.m. (9:30 a.m.)), an arrival time (e.g., five p.m. (5 p.m.)), a pick-up time, and/or a drop-off time. In some embodiments, the one or more travel times and/or the one or more deferred travel times can include a non-specific travel time that does not clearly define a specific travel time (e.g., sometime this afternoon or later today).

In some embodiments, the determination of whether the navigation request indicates, includes, and/or is associated with a specific location can be a separate operation from the determination of whether the navigation request indicates, includes, and/or is associated with a deferred travel time. In some embodiments, the determination of whether the navigation request indicates, includes, and/or is associated with a specific location can be performed in combination with and/or at the same time or similar time as the determination of whether the navigation request indicates, includes, and/or is associated with a deferred travel time.

By way of example, the computing system can parse the words in a navigation request to determine whether the navigation request includes some combination of words that is associated with a specific location (e.g., “home” or “the office”). By way of further example, the computing system can parse the words in a navigation request to determine whether the navigation request includes some combination of words that is associated with a deferred travel time. The computing system can determine that a navigation request that includes the words “right now,” “immediately,” and/or “now” can be determined to refer to the present time and determined not to indicate and/or include a deferred travel time (e.g., a deferred travel time that greater than a predetermined duration later than the current time).

In some embodiments, the computing system can determine that a navigation request that does not indicate any term associated with time is a navigation request that does not indicate a deferred travel time (e.g., a navigation request associated with an immediate travel time). Further, the computing system can determine that the navigation request does not indicate a deferred travel time when a time range is indicated (e.g., “this morning,” “this afternoon,” “after five,” “before it closes,” “when it opens” “tonight,” or “before three”). The computing system can use the determination of whether a specific location and/or a deferred travel time was indicated in the navigation request to determine the one or more locations and/or the one or more travel times that will be provided to the user. Further, the computing system can determine whether the deferred travel time indicates a specific time to arrive at a location (“be there at nine a.m.”), a specific time to depart for a location (“leave the location at six p.m.”), or some combination of one or more specific times to depart from a location and/or one or more specific times to arrive at a location. In some embodiments, the one or more travel times can include one or more deferred travel times and one or more travel times associated with immediate travel (e.g., travelling within some predetermined duration of the current time). For example, the one or more travel times can include a travel time associated with immediate or near-immediate (e.g., within five minutes) travel from the current location and one or more deferred travel times including a travel time an hour from the current time.

In some embodiments, the navigation request can include a specific time window to arrive at and/or depart from a location (“get there after five, but not later than six-thirty”). The specific time window can include a specific start time and a specific end time that indicate the limits of the specific time window. In some embodiments, the time window included in the output comprising one or more indications associated with navigation can be based at least in part on the specific time window. For example, if the navigation request includes a specific time window between one (1) o'clock p.m. and three (3) o'clock p.m. then the tine window indicated in the output will overlap at least some portion of the specific time window.

In some embodiments, the determination of whether the navigation request indicates a specific location and/or a deferred travel time is based at least in part on the use and/or application of one or more machine-learned models configured and/or trained to determine whether the navigation request specifies a specific location based at least in part on an input comprising the navigation request. For example, the one or more machine-learned models can be configured to determine whether the navigation request includes a specific location and/or deferred travel time based at least in part on training data including portions of text that include portions that indicate a specific location and a deferred travel time, portions that indicate a specific location and do not indicate a deferred travel time, portions that do not indicate a specific location and do indicate a deferred travel time, or portions that do not indicate either a specific location or a deferred travel time.

Further, the one or more machine-learned models can be configured and/or trained based at least in part on navigation requests provided by the user. In this way the accuracy of the one or more machine-learned models can improve over time and become better configured to suit the needs of a particular user. For example, the one or more machine-learned models can be configured and/or trained to learn various idiosyncrasies in the way a particular user writes and/or speaks. Further, the one or more machine-learned models can be configured and/or trained to use the user's context, past actions, and/or calendar of events to determine whether the navigation request indicates a specific location and/or a deferred travel time.

In some embodiments, the one or more machine-learned models can be configured to determine whether the navigation request indicates a specific location and/or a deferred travel time based at least in part on one or more natural language processing techniques. For example, the one or more machine-learned models can be configured and/or trained to determine the semantic content (e.g., one or more specific locations and/or one or more deferred travel times) that are present in navigation requests based on spoken language inputs that may be halting, ungrammatical, and/or use informal terminology.

Further, the one or more machine-learned models can perform one or more natural language understanding (NLU) operations to determine and/or extract semantic content from a navigation request. For example, the one or more machine-learned models can use natural language processing techniques to determine the context of the one or more messages and capture nuances and meaning that may be implicit in a navigation request without being expressly indicated. For example, the one or more machine-learned models can access navigation data that includes a navigation indicating “DINNER AT EIGHT AT THE SUMMER GARDEN” and use one or more natural language processing techniques to determine that “DINNER AT EIGHT” indicates that the navigation request includes a deferred travel time that includes a specific time of day and means eight (8) o'clock in the evening, since dinner is not consumed at eight (8) o'clock in the morning. Further, the one or more machine-learned models can determine that “THE SUMMER GARDEN” is a restaurant by the name of the Summer Garden, and that the restaurant is a specific location with a specific address.

In some embodiments, the input to the machine-learned models can include one or more audible inputs associated with the navigation request. Further, the one or more machine-learned models are configured to determine whether the navigation request specifies a specific location and/or a deferred travel time to travel to the location based at least in part on an application of the one or more natural language processing techniques to the one or more audible inputs (e.g., a navigation request spoken by the user).

The computing system can determine one or more locations and/or one or more travel times associated with fulfilling the navigation request. The determination of the one or more locations and/or the one or more travel times can be based at least in part on the navigation data. The one or more locations can be based at least in part on whether the navigation request indicates a specific location. Further, the one or more travel times can be based at least in part on whether the navigation request indicates a deferred travel time. In some embodiments, the computing system can determine a plurality of travel times that includes the one or more travel times. In some embodiments, the plurality of travel times can include one or more travel times that are not deferred (e.g., one or more immediate travel times to one or more locations) and/or one or more travel times that are deferred. For example, the plurality of travel times can include one or more deferred travel times and one or more non-deferred travel times, two or more deferred travel times, or two or more non-deferred travel times. In some embodiments, the plurality of travel times includes one or more deferred travel times.

In some embodiments, the one or more locations and/or the one or more travel times can be based at least in part on one or more estimated round-trip travel durations or one or more estimated one-way travel durations. As such, the one or more locations and/or the one or more travel times may change based at least in part on whether the user is travelling one-way or making a round-trip.

Each of the one or more locations can be associated with one or more respective routes from a starting location (e.g., the current location of the computing system) to a respective location of the one or more locations. For example, the computing system can generate at least one route for each of the one or more locations. Further, each of the one or more locations may be associated with one or more routes based at least in part on the travel time. For example, the route to a single location may change based at least in part on the travel time that is associated with the route. If the user chooses to travel at one (1) o'clock in the afternoon a first route may be generated and if the user chooses to travel at three (3) o'clock in the afternoon a second different route may be generated.

For example, if the navigation request indicates a specific location and a deferred travel time, the computing system can determine a location and travel time that correspond to the specific location and the deferred travel time (e.g., the navigation request indicates “go to the office right now”). If the navigation request indicates a specific location and does not indicate a deferred travel time, the computing system can determine a location that corresponds to the specific location and one or more travel times that will allow the user to arrive at the specific location within a time window that may be a predetermined time window (e.g., today, this afternoon, within the next three hours) or a flexible time window that changes based on context (e.g., the time of day and/or the location of the user). If the navigation request does not indicate a specific location and does indicate a deferred travel time, the computing system can determine one or more alternative locations that can substitute for the location in the navigation request (e.g., a restaurant food chain in which each restaurant offers the same menu items) and one or more travel times that will allow the user to arrive at the non-specific location within a time window that may include a predetermined time window (e.g., today, this afternoon, within the next three hours) or a flexible time window that changes based on context (e.g., the time of day and/or the location of the user). If the navigation request does not indicate either a specific location or a deferred travel time, the computing system can determine one or more alternative locations that can substitute for the location in the navigation request (e.g., a pharmacy chain that offers the same items at each of its locations) and one or more travel times that will allow the user to arrive at the non-specific location within a time window (e.g., a time window that includes the times during which the location (a pharmacy) is open for business).

In some embodiments, the time window can be based at least in part on one or more distance constraints and/or one or more time constraints. The one or more distance constraints can include a threshold distance (e.g., a maximum distance) associated with the user travelling to the one or more locations. The maximum distance can be based at least in part on some multiplier of the minimum distance between the starting location and the destination (e.g., a minimum distance along one or more roads or a shortest straight distance between the current location and the location being travelled to). For example, the maximum distance can be two (2) times the minimum driving distance between the current location and the location being travelled to.

Further, the one or more time constraints can include a threshold travel duration (e.g., a maximum travel duration) for the user to travel to any of the one or more locations. The threshold travel duration can be some multiple of the (e.g., two (2)) of the minimum estimated travel duration between the current location of the computing device operated by the user and a location. For example, if the estimated travel duration between the current location and the destination is twenty (20) minutes, none of the one or more travel times be associated with a duration that exceeds forty (40) minutes.

In some embodiments, if the navigation request is determined not to indicate and/or include a specific location, the computing system can determine that more than one location (e.g., a plurality of locations) is provided. For example, if the navigation request indicates “NAVIGATE TO A GROCERY STORE” then the computing system can determine a plurality of locations. The plurality of locations can include any combination of locations that are of the same type and/or within some threshold similarity of the location indicated and/or included in the navigation request. For example, the plurality of locations can include a grocery store that is currently the shortest travel duration (thirty (30) minutes travel duration) for the user and another grocery store that will be a shorter travel duration (twenty (20) minutes travel duration) one hour from the current time.

The computing system can generate output. The output can include one or more indications associated with navigation by the user to at least one of the one or more locations during a time window that can include at least one of the one or more travel times. Further, the computing system can generate output including one or more visual indications including a time window (e.g., two (2) o'clock p.m. to four (4) o'clock p.m.) and at least one location (e.g., the user's home) that are based at least in part on the navigation data. In some embodiments, output can be based at least in part on navigation data that is continuously updated. As such, in the event that the user has chosen to defer travel, the one or more locations and/or the one or more travel times may change as the conditions (e.g., traffic conditions) at the one or more locations change.

By way of example, if the navigation request indicates a specific location (e.g., the user's home) and does not indicate a deferred travel time (e.g., a current time (e.g., immediately) is indicated), the output can include the indication “TAP HERE TO GENERATE A ROUTE HOME FOR IMMEDIATE DEPARTURE.” If the navigation request indicates a specific location (e.g., the user's office) and does not indicate a deferred travel time, the output can include the indications including a first indication that indicates “TAP HERE TO GENERATE A ROUTE TO THE OFFICE FOR IMMEDIATE DEPARTURE.” and a second indication that indicates “TAP HERE TO TRAVEL TO THE OFFICE AT SIX-THIRTY A.M. OR NINE-THIRTY A.M.” If the navigation request does not indicate a specific location (e.g., a fast food chain restaurant by the name of “BURGER CAFE”) and indicates a deferred travel time (e.g., depart at three (3) p.m. this afternoon), the output can include the indications including a first indication that indicates “TAP HERE TO GENERATE A ROUTE TO THE BURGER CAFE ON MAIN STREET FOR DEPARTURE AT THREE P.M., WHICH IS ESTIMATED TO HAVE A TRAVEL DURATION OF THIRTY MINUTES” and a second indication that indicates “TAP HERE TO TRAVEL TO THE BURGER CAFE ON BRICK STREET FOR DEPARTURE BEFORE THE SPECIFIED TIME OF THREE O'CLOCK, WHICH IS ESTIMATED TO HAVE A TRAVEL DURATION OF FIFTEEN MINUTES.” If the navigation request does not indicate a specific location (e.g., a fast food chain restaurant) and also does not indicate a deferred travel time, the output can include the indications including a first indication that indicates “TAP HERE TO GENERATE A ROUTE TO THE BURGER CAFE ON MAIN STREET FOR IMMEDIATE DEPARTURE WHICH IS ESTIMATED TO HAVE A TRAVEL DURATION OF THIRTY MINUTES” and a second indication that indicates “TAP HERE TO TRAVEL TO THE BURGER CAFE ON BRICK STREET FOR DEPARTURE BETWEEN FOUR P.M AND FIVE P.M. WHICH IS ESTIMATED TO HAVE A TRAVEL DURATION OF FIFTEEN MINUTES.”

In some embodiments, the time window can be narrow (e.g., the next five seconds) and can be indicated by the user as “NOW,” “IMMEDIATELY,” and/or “AS SOON AS POSSIBLE.” Further, in some embodiments, the navigation request can include a time window that is indicated. For example, the navigation request can indicate that the user would prefer to arrive at a location within the next hour.

In some embodiments, the output can include one or more routes from the current location of the computing system and/or the user to the one or more locations at the one or more travel times. For example, one or more routes from the current location to the one or more locations can be determined by accessing the navigation data and determining one or more roads that allow the user to travel from the current location to the one or more locations. Further, the output can arrange the one or more routes based at least in part on time constraints (e.g., travel within a specified time or time window; and/or a travel duration that imposes an upper limit on travel duration), distance constraints (e.g., the one or more routes do not exceed a distance threshold), and/or a location constraint when the navigation request indicates that the user has indicated a specific location to travel to.

Further, the computing system can generate output including a map of the geographic area including the current location of the computing system and the one or more locations. The map can include a travel time associated with each of the one or more locations. Further, the map can be configured to allow the user to select a location and/or travel time on the map. For example, the user can select a location and/or a travel time by touching the respective location and/or travel time on the map.

The computing system can receive one or more inputs from a user. Further, the one or more inputs can include a user selected location and/or a user selected time range. The user selected location and/or the user selected time range can be selected from the one or more locations. In some embodiments, the user selected time range can be selected from the one or more travel times. For example, the user can speak to indicate the selection of a location and/or a travel time. Further, the user can use a graphical user interface to touch a selected location and/or travel time that is displayed on a display device of the computing system.

The computing system can generate one or more navigation indications including one or more routes from a current location of the user to the user selected location within the user selected time range or the user selected time. The one or more routes from the current location (e.g., the current location of a computing device operated by a user) to the user selected location can be determined based at least in part on the navigation data. For example, one or more routes from the current location to the user selected location can be determined by accessing the navigation data and determining one or more roads that connect the current location and the user selected location. By way of further example, the computing system can use the user selected route to determine the one or more routes, one or more roads, and/or user accessible areas (e.g., sidewalks, cycling paths, foot paths, and/or paved areas) between the current location of the user and the one or more locations. The computing system can then determine one or more navigation indications to direct the user to the user selected location.

The computing system can determine a combination of the location of the one or more locations and/or the travel time of the one or more travel times that is associated with a shortest travel duration within the time window of the one or more travel times. In some embodiments, the computing system can determine a combination of the location of the one or more locations and/or the travel time of the one or more travel times that is associated with a travel duration that is less than a threshold travel duration. The output can include the combination of the location and the travel time that is associated with the shortest travel duration and/or the combination of the location of the one or more locations and/or the travel time of the one or more travel times that is associated with a travel duration that is less than a threshold travel duration.

The computing system can determine one or more time savings for the user based at least in part on one or more differences in travel duration between the user travelling to the one or more locations immediately and the user travelling to the one or more locations at the one or more travel times, wherein the output can include the one or more time savings. For example, the computing system can subtract the travel duration associated with each of the one or more travel times from the travel duration associated with traveling immediately. The computing system can then provide indications (e.g., display the one or more time savings and/or announce the one or more time savings) to the user.

The computing system can, in response to the navigation request indicating a specific location, generate output comprising a request for confirmation from the user that the user indicated a specific location. For example, the computing system can generate one or more audible indications requesting the user to confirm that the user is requesting a route to a particular restaurant.

The computing system can, in response to the navigation request not indicating a specific location, determine a location type associated with the navigation request. For example, if the navigation request indicates a specific supermarket, the computing system can determine that the specific supermarket belongs to the supermarket location type. The determination of the location type can be based at least in part on one or more heuristics (e.g., a dictionary of key words associated with specific location types) and/or one or more machine-learned models that are configured and/or trained to determine a location type based at least in part on input that can include the navigation request. Further, the one or more machine-learned models can be configured and/or trained to analyze and/or parse the navigation data. In some embodiments, the one or more machine-learned models can be configured and/or trained to analyze and/or parse the navigation request to determine one or more entities (e.g., names of locations and/or names of objects) that are included in the navigation request. Based at least in part on the one or more entities associated with the navigation request, the one or more machine-learned models can be configured and/or trained to determine one or more similarities between the one or more entities associated with the navigation request and one or more map entities associated with one or more locations in map data/location data/geographic data that includes information associated with one or more locations in a geographic area. The one or more machine-learned models can then generate output including one or more locations associated with the one or more map entities that satisfy one or more similarity criteria (e.g., a threshold level of similarity) with respect to the one or more entities.

By way of example, in the event that the navigation request includes “SUPERMARKET WITH MELONS” the one or more machine-learned models can use the navigation request as an input that is used to determine the one or more locations within a predetermined distance that are similar to the location indicated in the navigation request (e.g., supermarkets and/or grocery stores that sell melons and are located within some threshold distance of the user). In the event that the one or more locations in the geographic area do not match the navigation request, the computing system can indicate an amount of similarity with the navigation request (e.g., supermarkets that do not sell melons or supermarkets that sell fruit but not melons in particular). By way of further example, in the event that the navigation request includes “NAVIGATE TO SOMETHING LIKE STAR MART” in which “STAR MART” is the name of a chain of supermarkets that are large and offer a very wide range of products, the one or more machine-learned models can use the navigation request as an input to determine the one or more locations within a predetermined distance and/or travel time that are similar to the location indicated in the navigation request (e.g., large supermarkets). Further, the computing system can indicate other locations that are similar to the location indicated in the navigation request that do not match (e.g., small supermarkets).

In some embodiments, the one or more machine-learned models can be configured and/or trained to receive/access input including one or more portions of the navigation request and/or one or more map entities, perform one or more operations on the input and generate output including one or more locations and/or one or more corresponding similarity values indicating the similarity of each of the one or more locations to the one or more map entities. For example, the input to the one or more machine-learned models can include the name of a restaurant (e.g., “LIN'S DUMPLING DINER” which is a chain of restaurants that serve Chinese food) extracted from a navigation request and one or more map entities including business locations in the geographic area within twenty kilometers of the user that made the navigation request. The one or more machine-learned models can generate output including one or more names of restaurants within a predetermined distance of the user. If a “LIN'S NOODLE DINER” restaurant is included in the output, the similarity can be indicated as “100% SIMILAR” If a restaurant that is not a “LIN'S NOODLE DINER” is included in the output, the more similar restaurants (e.g., Chinese restaurants that serve noodles) will have a higher similarity (e.g., 90%) than other restaurants that do not serve Chinese food and/or noodles.

Further, the computing system can determine one or more alternative locations that match the location type associated with the navigation request. For example, if the navigation request includes a specific supermarket, the computing system can determine the locations of other supermarkets that are not the specific supermarket indicated in the navigation request. The other supermarkets may include supermarkets that have shorter travel durations. Further, the output and/or the one or more locations can include the one or more alternative locations. In some embodiments, the specified location can be included in the output. The one or more alternative locations can include locations that can be used as a substitute for the location indicated in the navigation request. Further, the one or more alternative locations may be associated with varying degrees of fungibility with respect to the goods and/or services that may be provided at the location. For example, a user searching for a pharmacy may result in the computing system providing a general store with a pharmacy section as an alternative location.

In some embodiments, the computing system can determine one or more alternative locations that are within a predetermined range of similarity of the location type associated with the navigation request. For example, if the navigation request indicates a “CORNER STORE,” the location type can include small stores and the one or more alternative locations can include one or more gas stations that include small convenience stores that may be similar to the “CORNER STORE” indicated in the navigation request.

In some embodiments, the output can include a request for feedback from the user with respect to whether the user prefers to defer navigation. For example, the computing system can generate one or more audible indications indicating “WOULD YOU PREFER TO TRAVEL AT A LATER TIME?” when a later travel time may be of significantly shorter duration (e.g., a duration that is a threshold amount of time shorter than the travel duration associated with travelling immediately and/or a duration that is a threshold proportion (e.g., fifty percent (50%)) shorter than the travel duration associated with travelling immediately). The computing system can access, receive, obtain, and/or retrieve the feedback from the user via one or more user interfaces of the computing system. For example, after generating output that includes one or more audible indications (e.g., synthetic speech generated via one or more speakers of the computing system) of the request for feedback and/or one or more visual indications (e.g., text displayed on a display device of the computing system) of the request for feedback, the computing system can receive the user's feedback in the form of a spoken response by the user and/or a tactile user interaction with a user interface of the computing system.

The computing system can perform one or more operations based at least in part on the feedback from the user. The one or more operations can include modifying one or more heuristics associated with determining whether the navigation request specifies a specific location or a deferred travel time to travel to the location, and/or training one or more machine-learned models that are configured to determine whether the navigation request specifies a specific location or a deferred travel time to travel to the location. In some embodiments, the output can include a request for feedback from the user with respect to the one or more locations or the one or more travel times.

In some embodiments, the computing system can generate output including a request for feedback after a user has arrived at their destination. The feedback can request the relevance of an alternative location of a specific location was not travelled to and/or location attributes associated with the destination including waiting times and/or traffic at the location. The feedback from the user can be used as a training input for the one or more machine-learned models, which can be adjusted based at least in part on the input.

The computing system can access event data comprising information associated with a schedule of the user or travel history of the user. The event data can include one or more times at which the user is scheduled to perform one or more activities and can be used to determine the user's availability at various times. Further, the travel history of the user can include one or more locations at which the user was present in the past. The travel history of the user can be used to estimate the availability of the user if the user's availability for a future time is not indicated in the event data.

The computing system can determine, based at least in part on the event data, that the one or more travel times do not include any time that the user is not available to travel. For example, the computing device can compare the one or more travel times to the event data to determine any time the user is not available to travel (e.g., when the user is at work).

The computing system can determine, based at least in part on the event data, that the one or more locations do not include any location greater than a threshold distance away from a location where the user is scheduled to be present during the one or more travel times. For example, the computing system can access the event data and determine one or more locations where the user is scheduled to be present and determine whether the one or more locations are greater than the threshold distance away from the one or more locations.

In some embodiments, the output can include a notification that is generated within a predetermined amount of time of the earliest travel time of the one or more travel times that the user is available to travel. For example, the computing system can notify the user five (5) minutes before the earliest of the one or more travel times that the user is available to travel.

The computing system can determine, based at least in part on traffic data, the one or more travel times associated with less than a threshold amount of road traffic at the one or more locations. The traffic data can include information associated with road traffic (e.g., the amount of road traffic including traffic congestion) in a geographic region associated with the navigation request. The traffic data can include real-time information and/or historical road traffic information indicating the amount of road traffic at different locations in the past. In some embodiments, the traffic data can be included as part of the navigation data. Further, the output can include the one or more travel times associated with less than the threshold amount of road traffic at the one or more locations. For example, the computing system can determine that the one or more travel times will not include the one or more travel times that coincide with traffic density that is greater than a threshold density of road traffic (e.g., absent a specific deferred travel time in the navigation request and/or the unavailability of a location, travel times that coincide with rush hour will tend not to be included).

The computing system can monitor the navigation data and/or traffic data on a continuous or near-continuous basis. As such, the computing system can generate output including a notification to the user when the circumstances associated with travelling to a location change. For example, if a road closes the computing system may generate a different set of the one or more travel times than before the road closure.

The computing system can determine a combination of the location of the one or more locations and the travel time of the one or more travel times that are associated with a shortest travel distance. Further, the output can include the combination of the location and the travel time that is associated with the shortest travel distance. For example, the computing system can determine the shortest travel distance associated with every combination of the one or more locations and the one or more travel times to determine the one or more travel times associated with the shortest travel distance.

In some embodiments, the output can include one or more visual indications. Further, the one or more visual indications can be presented on a map of a geographic area that can include a portion of the one or more locations. For example, the one or more visual indications can be presented on a graphical user interface that includes a map of a geographic area that includes the current location of the computing system in relation to the one or more locations. Further, in some embodiments, the computing system can update the current location of the computing system in real time.

In some embodiments, the output can include one or more audible indications. Further, the one or more audible indications can indicate the time window of the one or more travel times for the user to travel to at least one of the one or more locations. Further, the one or more audible indications can include the one or more locations, the one or more travel times, a specific location, and/or a deferred travel time.

In some embodiments, the output can include one or more turn-by-turn directions for navigation to the one or more locations. For example, the computing system can generate one or more turn-by-turn instructions that indicate to the user, via one or more written instructions on a display device and/or one or more audible indications, where to turn as the navigate to a location (e.g., a specific location or an alternative location).

In some embodiments, the navigation request can be based at least in part on one or more inputs which can include one or more actions, and/or one or more interactions of the user. The one or more inputs can include one or more tactile inputs with respect to a graphical user interface of a navigation application (e.g., the user can touch an interface element of a graphical user interface in which the interface element is associated with a location), one or more textual inputs to the navigation application (e.g., typing a location and/or time using a physical keyboard or onscreen keyboard), and/or one or more spoken statements by the user (e.g., a user providing a navigation request by speaking into a microphone).

The disclosed technology can include a computing system (e.g., a navigation computing system) that is configured to perform various operations associated with the generation of flexible navigation indications with which a user can be provided with one or more locations and/or one or more travel times based on the user's navigation request. In some embodiments, the computing system can be associated with various computing systems and/or computing devices that access, use, send, receive, and/or generate a time window and/or locations (e.g., alternative locations) for use in flexible navigation by a user. Furthermore, the computing system can access, generate, process, modify, and/or communicate (e.g., send, and/or receive) data and/or information including data and/or information associated with a time window of one or more travel times for a user to travel to at least one location.

The computing system can include specialized hardware and/or software that enable the performance of one or more operations specific to the disclosed technology. The computing system can include one or more application specific integrated circuits that are configured to perform operations associated with accessing a navigation request from a user, determining whether the navigation request indicates a specific location or a deferred travel time, determining locations and/or travel times to fulfill the navigation request, and generating output including indications associated with a time window to travel to a least one location. By way of example, the computing system can be configured to control one or more vehicle systems of a vehicle based at least in part on the user's request for navigation to a destination. The one or more vehicle systems can include operational systems that are used to control operation of a vehicle and guide the vehicle to a destination along at a user specified time and along a user specified route.

Additionally, the computing system can be configured to generate data used to implement indications associated with a time window to travel to a least one location. The one or more indications can include one or more visual indications and/or one or more audible indications. For example, the computing system can generate one or more visual indications including a time window including deferred travel times and corresponding travel locations.

The systems, methods, devices, apparatuses, and tangible non-transitory computer-readable media in the disclosed technology can provide a variety of technical effects and benefits including an improvement in navigation by way of providing users with flexible navigation locations and travel times. In particular, the disclosed technology may assist a user (e.g. a user of a navigation device) in performing technical tasks by means of a continued and/or guided human-machine interaction process in which a time window and potential alternative locations are provided to a user on the basis of the user's navigation request (e.g., whether the user's request indicated a specific location or deferred travel time). Furthermore, the disclosed technology may also provide additional benefits including better resource usage efficiency, a reduction in adverse environmental impact, and improved safety.

Route-guidance information can be provided to a user in dependence and/or based at least in part on the user's position and the other real world data and variables as described herein. The systems, methods, devices, apparatuses, and tangible non-transitory computer-readable media in the disclosed technology can each involve an interaction between the user and the navigation system, wherein the navigation system measures the user's position and other real world data using technical means and, on the basis of these measurements, provides the user with information aimed at enabling the user to manage the technical task of moving to a desired destination in a more efficient manner.

The disclosed technology can improve the efficiency of resource consumption (e.g., a reduction in the amount of energy used in processing by a computing system, the amount of network bandwidth that is consumed, and the amount of fuel and electrical energy that are used by various devices). In particular, by generating output including a flexible time window and alternative locations to travel to, the disclosed technology can reduce travel time and thereby reduce excessive energy use and pollution. Further, the determination of a flexible time window and/or alternative travel locations may result in a reduction in traffic congestion since the user's travel can be scheduled to take place at a more efficient time or to a relatively equivalent location that is closer to the user and/or linked to the user's location by a route that has less traffic. As a result, the technology can provide a reduction in computer processing and/or bandwidth utilization.

The disclosed technology can also reduce the adverse environmental impact associated with low efficiency travel such as when an acceptable alternative location (e.g., an alternative supermarket that offers the same or similar goods as the supermarket location requested by a user) is closer to the user than the user's requested location or when delaying travel may reduce travel time. In these ways, the disclosed technology can provide the benefits of a reduction in the amount of pollution that is produced during travel. In addition, the technology can provide a reduction in computer processing and/or bandwidth utilization, for example because the computing system may operate to direct the user along a route for a shorter period due to the reduction in travel time.

Further, the disclosed technology can provide the technical effect of improving the efficiency with which navigational tasks are performed. For example, the computing system associated with generating flexible navigation indications can be continuously updated in response to user feedback associated with the suitability of navigation indications provided to the user. For example, one or more machine-learned models that are used as part of the process of providing flexible navigation indications can be continuously trained and/or updated in response to a user's use of the navigation indications and/or in response to direct feedback from the user.

The disclosed technology can improve the safety of navigating a vehicle by providing flexible navigation options that may allow the user to travel at times when there is less traffic on the road. In this way the user can operate a vehicle in an environment with fewer vehicles and/or pedestrians, thereby reducing the number of distractions and allowing the user to direct the vehicle more safely.

As such, the disclosed technology may assist the user of a navigation device in more effectively performing a variety of tasks with the specific benefits of reduced resource consumption, reduced environmental impact, improved navigational efficiency, and improved safety. Further, any of the specific benefits provided to users can be used to improve the effectiveness of a wide variety of devices and services including navigation devices and/or navigation applications. Accordingly, the improvements offered by the disclosed technology can result in tangible benefits to a variety of devices and/or systems including mechanical, electronic, and computing systems associated with navigation.

With reference now to the Figures, example embodiments of the present disclosure will be discussed in further detail.

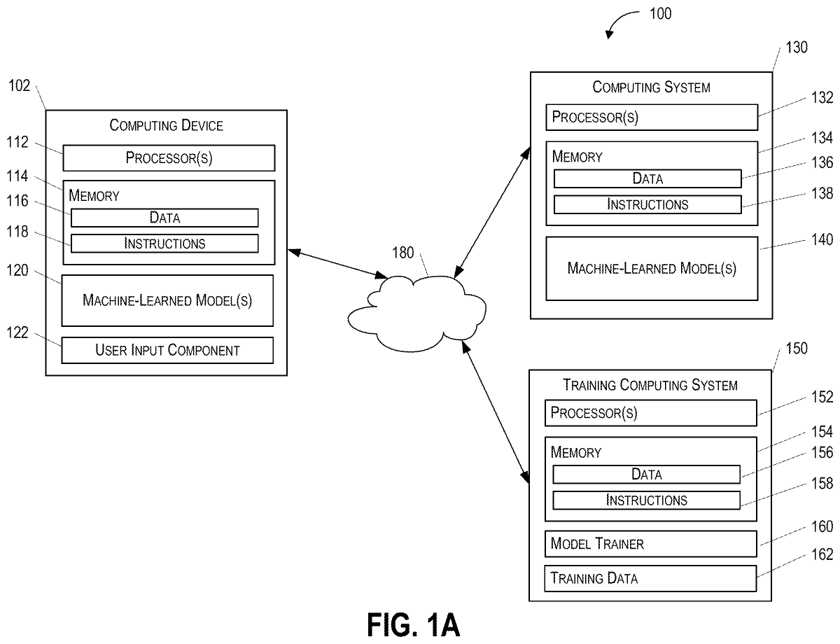

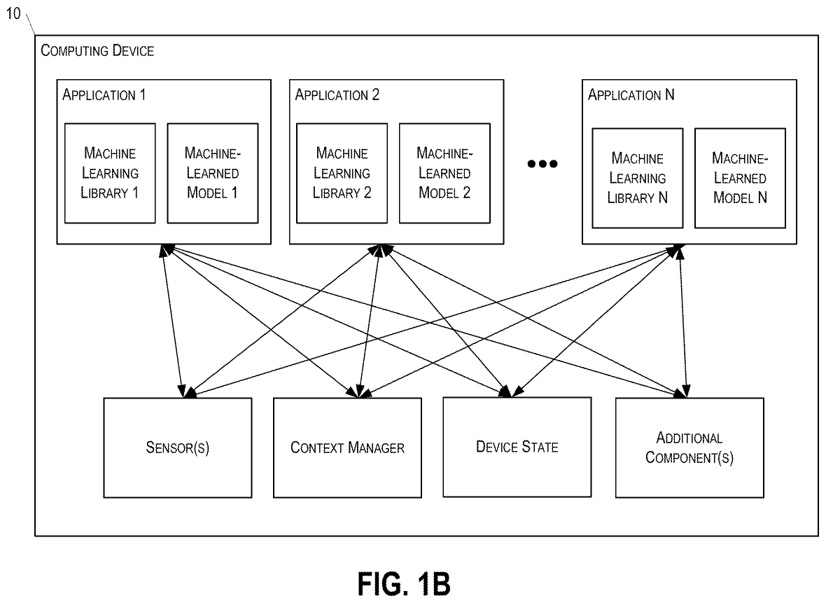

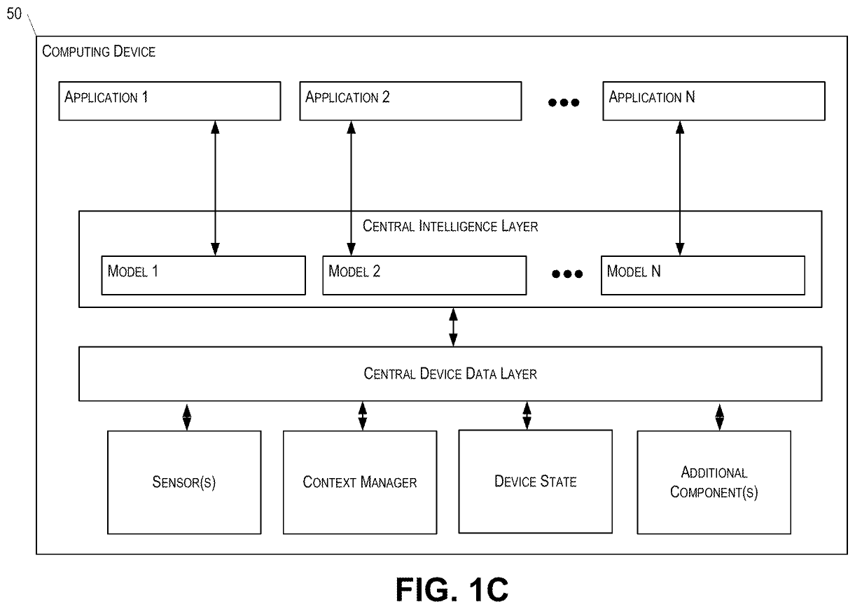

FIG. 1A depicts a block diagram of an example of a computing system 100 that performs operations associated with flexible navigation according to example embodiments of the present disclosure. The system 100 includes a computing device 102, a computing system 130 (e.g., a server computing system 130), and a training computing system 150 that are communicatively coupled over a network 180.

The computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the computing device 102 to perform operations.

In some implementations, the computing device 102 can store or include one or more machine-learned models 120. For example, the one or more machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Examples of one or more machine-learned models 120 are discussed with reference to FIGS. 1A-14.

In some implementations, the one or more machine-learned models 120 can be received from the computing system 130 over network 180, stored in the memory 114, and then used or otherwise implemented by the one or more processors 112. In some implementations, the computing device 102 can implement multiple parallel instances of a single machine-learned model 120 (e.g., to perform parallel operations to determine and/or generate indications associated with a user travelling to at least one location during a time window comprising one or more travel times).

More particularly, the one or more machine-learned models 120 can be configured and/or trained to access event data, traffic data, and/or navigation data including a navigation request from a user; determine whether the navigation request indicates a specific location or a deferred travel time; determine locations and/or travel times to fulfill the navigation request; and/or generate output including indications associated with the user travelling to a least one location during a time window that includes one or more travel times.

Additionally, or alternatively, one or more machine-learned models 140 can be included in or otherwise stored and implemented by the computing system 130 that communicates with the computing device 102 according to a client-server relationship. For example, the one or more machine-learned models 140 can be implemented by the server computing system 130 as a portion of a web service (e.g., a navigation service that provides travel times and/or travel locations to a user). Thus, one or more machine-learned models 120 can be stored and implemented at the computing device 102 and/or one or more machine-learned models 140 can be stored and implemented at the server computing system 130.

The computing device 102 can also include one or more of the user input component 122 that is configured to receive user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the computing system 130 to perform operations.

In some implementations, the computing system 130 includes or is otherwise implemented by one or more server computing devices. In instances in which the computing system 130 includes plural server computing devices, such server computing devices can operate according to sequential computing architectures, parallel computing architectures, or some combination thereof.

As described above, the computing system 130 can store or otherwise include one or more machine-learned models 140. For example, the one or more machine-learned models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 1A-15.

The computing device 102 and/or the computing system 130 can train the one or more machine-learned models 120 and/or 140 via interaction with the training computing system 150 that is communicatively coupled over the network 180. The training computing system 150 can be separate from the computing system 130 or can be a portion of the computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the computing device 102 and/or the computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the one or more machine-learned models 120 and/or the one or more machine-learned models 140 based on a set of training data 162. The training data 162 can include, for example, one or more navigation requests including text based content and/or auditory content associated with various locations and times to depart and/or arrive at a location.

In some implementations, if the user has provided consent, the training examples can be provided by the computing device 102. Thus, in such implementations, the one or more machine-learned models 120 provided to the computing device 102 can be trained by the training computing system 150 on user-specific data received from the computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can include image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text and/or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic output associated with the semantic content of a text or natural language input. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can include speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is of higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the computing device 102 can include the model trainer 160 and the training data 162. In such implementations, the one or more machine-learned models 120 can be both trained and used locally at the computing device 102. In some of such implementations, the computing device 102 can implement the model trainer 160 to personalize the one or more machine-learned models 120 based on user-specific data.

FIG. 1B depicts a block diagram of an example of a computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a navigation application, a mapping application, a routing application, an e-mail application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example of a computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a navigation application, a mapping application, a routing application, an e-mail application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

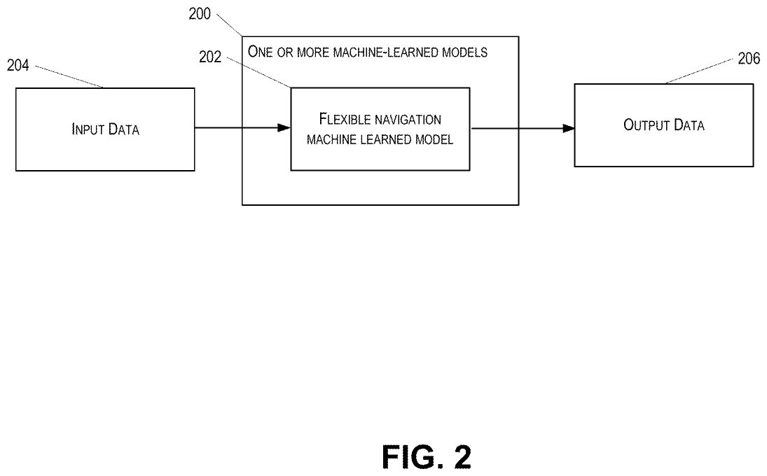

FIG. 2 depicts a block diagram of an example of one or more machine-learned models 200 according to example embodiments of the present disclosure. In some implementations, the one or more machine-learned models 200 are trained to access and/or receive a set of input data 204 descriptive of a navigation request (e.g., a navigation request for a user to travel to a location and which may include a specific location and/or a deferred travel time for the user to travel) and, after performing one or more operations on the input data 204, generating output data 206 that includes information associated with one or more locations and a time window including one or more times to travel to the one or more locations. The output may also include a specific location and/or a deferred travel time indicated in the navigation request. Thus, in some implementations, the one or more machine-learned models 200 can include a flexible navigation machine-learned model 202 that is operable to generate output associated with indications of locations and times that allow a user to travel more effectively (e.g., shorter travel duration and/or shorter travel distance).

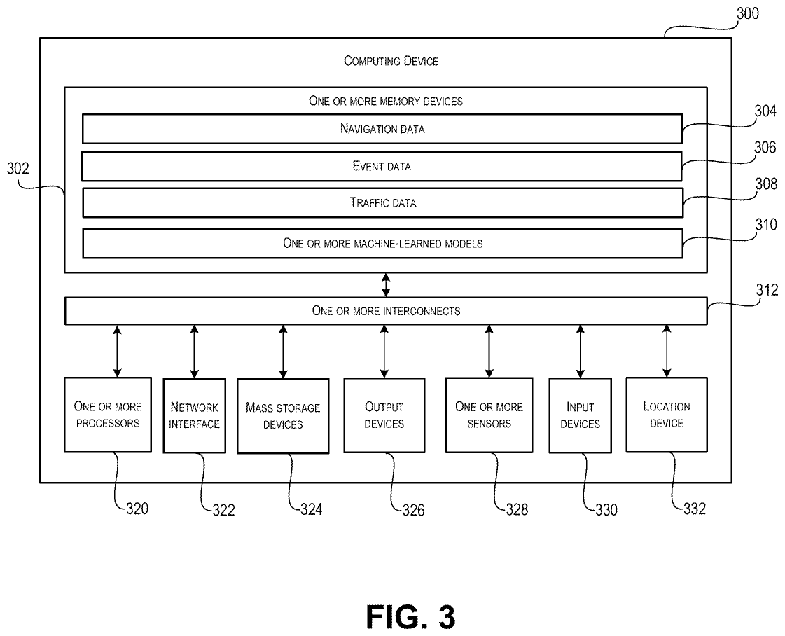

FIG. 3 depicts a diagram of an example computing device according to example embodiments of the present disclosure. A computing device 300 can include one or more attributes and/or capabilities of the computing device 102, the computing system 130, and/or the training computing system 150. Furthermore, the computing device 300 can perform one or more actions and/or operations including the one or more actions and/or operations performed by the computing device 102, the computing system 130, and/or the training computing system 150, which are depicted in FIG. 1A.

As shown in FIG. 3, the computing device 300 can include one or more memory devices 302, navigation data 304, event data 306, one or more machine-learned models 310, one or more interconnects 312, one or more processors 320, a network interface 322, one or more mass storage devices 324, one or more output devices 326, one or more sensors 328, one or more input devices 330, and/or the location device 332.

The one or more memory devices 302 can store information and/or data (e.g., the navigation data 304, the event data 306, and/or the one or more machine-learned models 310). Further, the one or more memory devices 302 can include one or more non-transitory computer-readable storage media, including RAM, ROM, EEPROM, EPROM, flash memory devices, magnetic disks, and combinations thereof. The information and/or data stored by the one or more memory devices 302 can be executed by the one or more processors 320 to cause the computing device 300 to perform operations including operations associated with generating one or more indications for flexible navigation by a user.

The navigation data 304 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the navigation data 304 can include information associated with one or more locations, including one or more routes from a current location to a destination that can be implemented on the computing device 300. In some embodiments, the navigation data 304 can be received from one or more computing systems (e.g., the computing system 130 that is depicted in FIG. 1) which can include one or more computing systems that are remote (e.g., in another room, building, part of town, city, or nation) from the computing device 300.

The event data 306 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the event data 306 can include information associated with events scheduled for a user (e.g., a calendar of a user that indicates the user's availability) and that can be implemented on the computing device 300. In some embodiments, the event data 306 can be received from one or more computing systems (e.g., the computing system 130 that is depicted in FIG. 1) which can include one or more computing systems that are remote from the computing device 300.

The traffic data 308 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the traffic data 308 can include information associated with amounts of road traffic and/or traffic patterns in a geographic area and that can be implemented on the computing device 300. In some embodiments, the traffic data 308 can be received from one or more computing systems (e.g., the computing system 130 that is depicted in FIG. 1) which can include one or more computing systems that are remote from the computing device 300.

The one or more machine-learned models 310 (e.g., the one or more machine-learned models 120 and/or the one or more machine-learned models 140) can include one or more portions of the data 116, the data 136, and/or the data 156 which are depicted in FIG. 1A and/or instructions (e.g., the instructions 118, the instructions 138, and/or the instructions 158 which are depicted in FIG. 1A) that are stored in the memory 114, the memory 134, and/or the memory 154, respectively. Furthermore, the one or more machine-learned models 310 can include information associated with accessing navigation data (that includes a navigation request), event data, and/or traffic data; determining whether the navigation request indicates a specific location or a deferred travel time one or more routes; determining one or more locations and one or more travel times; and generating output associated with user navigation to one or more locations within a time window including the one or more travel times. In some embodiments, the one or more machine-learned models 310 can be received from one or more computing systems (e.g., the computing system 130 that is depicted in FIG. 1) which can include one or more computing systems that are remote from the computing device 300.

The one or more interconnects 312 can include one or more interconnects or buses that can be used to send and/or receive one or more signals (e.g., electronic signals) and/or data (e.g., the navigation data 304, the event data 306, the traffic data 308, and/or the one or more machine-learned models 310) between components of the computing device 300, including the one or more memory devices 302, the one or more processors 320, the network interface 322, the one or more mass storage devices 324, the one or more output devices 326, the one or more sensors 328 (e.g., a sensor array), and/or the one or more input devices 330. The one or more interconnects 312 can be arranged or configured in different ways including as parallel or serial connections. Further the one or more interconnects 312 can include one or more internal buses to connect the internal components of the computing device 300; and one or more external buses used to connect the internal components of the computing device 300 to one or more external devices. By way of example, the one or more interconnects 312 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), and/or one or more graphics processing units (GPUs). Further, the one or more processors 320 can perform one or more actions and/or operations including one or more actions and/or operations associated with the navigation data 304, the event data 306, the traffic data 308, and/or the one or more machine-learned models 310. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). The one or more mass storage devices 324 (e.g., a hard disk drive and/or a solid state drive) can be used to store data including the navigation data 304, the event data 306, the traffic data 308, and/or the one or more machine-learned models 310. The one or more output devices 326 can include one or more display devices (e.g., LCD display, OLED display, Mini-LED display, microLED display, plasma display, and/or CRT display), one or more light sources (e.g., LEDs), one or more loudspeakers, and/or one or more haptic output devices (e.g., one or more devices that are configured to generate vibratory output).

The one or more input devices 330 can include one or more keyboards, one or more touch sensitive devices (e.g., a touch screen display), one or more buttons (e.g., ON/OFF buttons and/or YES/NO buttons), one or more microphones, and/or one or more cameras.

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, network interfaces, which may be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output including the indications associated with navigation by the user. The one or more memory devices 302 can be used to operate various applications including a mobile operating system developed specifically for mobile devices. As such, the one or more memory devices 302 can store instructions that allow the software applications to access data including data associated with the generation of indications for flexible navigation by a user. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 1A. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or Wi-Fi hotspots, beacons, and the like and/or other suitable techniques for determining position.

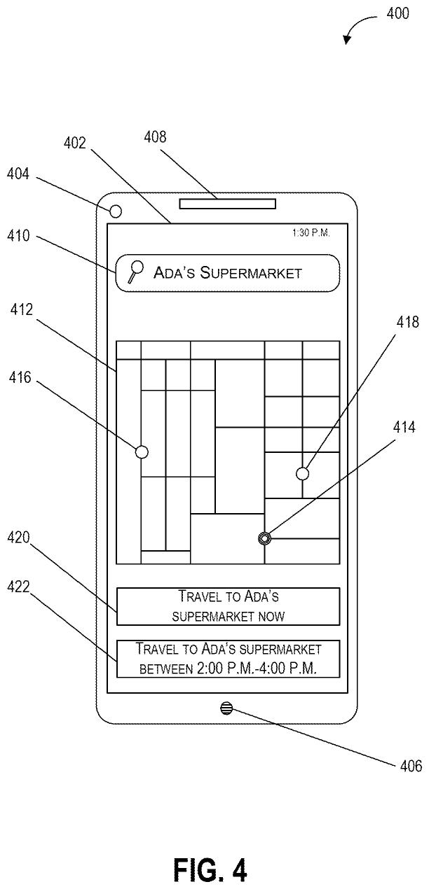

FIG. 4 depicts an example of a navigation system according to example embodiments of the present disclosure. A computing device 400 can include one or more attributes and/or capabilities of the computing device 102, the computing system 130, the training computing system 150, and/or the computing device 300. Furthermore, the computing device 400 can perform one or more actions and/or operations including the one or more actions and/or operations performed by the computing device 102, the computing system 130, the training computing system 150, and/or the computing device 300.

As shown in FIG. 4, the computing device 400 includes a display component 402, an imaging component 404, an audio input component 406, an audio output component 408, an interface element 410, an interface element 412, an interface element 414, an interface element 416, an interface element 418, an interface element 420, and an interface element 422.

The computing device 400 can be configured to perform one or more operations including accessing, processing, sending, receiving, and/or generating data including navigation data, event data, and/or traffic data, any of which can include information associated with one or more locations, one or more maps of one or more geographic areas, a calendar or schedule of a user. Further, the computing device 400 can receive one or more inputs including one or more user inputs from a user of the computing device 400. For example, a user can select a location (e.g., a destination the user may travel to) by selecting the interface element 410 which is displayed on the display component 402 that also shows the interface element 414 which indicates the location of the computing device 400.

In this example, a user has opened a navigation application on the computing device 400 and is searching for a supermarket nearby. The user has entered the search term “ADA'S SUPERMARKET” in the interface element 410 which is used to receive user inputs associated with a search for a location in a geographic area and is configured to receive one or more inputs including touch inputs (e.g., the user touching characters on a pop-up keyboard and spelling out the name of a location to travel to) and/or audible inputs (e.g., the user speaking the search term). In some embodiments, the search term entered into the interface element 410 can include a non-location that is then associated by the computing device 400 with a location. For example, the search terms that can be associated with a location by the computing device 400 can include: a personal name (e.g., the name of the user's sister) which can be associated with the location of the sister's house; the name of a product (e.g., “JUICE”) that can be associated with the location of a store at which “JUICE” is sold; and/or the name of a service (e.g., “PHYSICIANS”) that can be associated with the location of “PHYSICIAN” (e.g., a hospital or medical clinic).

The computing device 400 can determine the location of “ADA'S SUPERMARKET” at the interface element 410 that represents a location indicated on the interface element 412 (e.g., a map of the geographic area within a predetermined distance of the computing device 400) which also includes the interface element 414 that indicates the current location of the computing device 400. Additionally, the computing device 400 can determine that the search term “ADA'S SUPERMARKET” indicates a specific location because ADA's SUPERMARKET is a unique store.

In some embodiments, the computing device 400 can determine one or more travel times that the user can travel to ADA'S SUPERMARKET. The one or more travel times can include a travel time if the user travels to ADA'S SUPERMARKET immediately or nearly immediately (e.g., within a predefined time interval such as two (2) minutes). Further, the computing device 400 can determine one or more travel times that occur later in the day when the duration of the trip may be shorter than if the user travels to ADA'S SUPERMARKET immediately. By way of example, the computing device 400 can generate the interface element 420 which indicates “TRAVEL TO ADA'S SUPERMARKET NOW” and can generate a route to ADA'S SUPERMARKET if the user provides one or more inputs to the interface element 420 (e.g., the user touching the interface element 420 with their finger). Further, the computing device 400 can generate the interface element 422 which indicates “TRAVEL TO ADA'S SUPERMARKET BETWEEN 2:00 P.M.-4:00 P.M.” and can generate a route to an alternative location (e.g., the alternative location indicated by the interface element 418) if the user provides one or more inputs to the interface element 422 (e.g., the user touching the interface element 422 with their finger).

Further, in some embodiments, the computing device 400 can determine one or more locations (alternative locations) that the user can travel to instead of ADA'S SUPERMARKET. For example, the computing device 400 can include one or more machine-learned models and/or one or more heuristics that can be used to determine the type of location associated with the search term “ADA'S SUPERMARKET” and determine that ADA'S SUPERMARKET is a grocery store. The computing device 400 can then determine one or more grocery stores that may be closer to the computing device 400 than ADA'S SUPERMARKET and/or that would have a shorter travel duration than the user would experience by travelling to ADA'S SUPERMARKET. For example, the computing device 400 can generate the interface element 418 which indicates the location of another grocery store that is closer to the computing device 400 than ADA'S SUPERMARKET. The user can select the interface element 418 by touching the interface element 418, which, in some embodiments, can change the content of the interface element 420 to indicate “TRAVEL TO THE ALTERNATIVE LOCATION” and change the content of the interface element 422 to indicate “TRAVEL TO THE ALTERNATIVE LOCATION BETWEEN 2:00 P.M.-4:00 P.M.”

Furthermore, in some embodiments, the computing device 400 can generate output including a combination of one or more indications that include one or more locations and/or one or more travel times. For example, the computing device 400 can generate output including a list of locations (e.g., various grocery stores) and corresponding travel times (e.g., travel times including travel times that are of shorter duration than travelling immediately).

In some embodiments, the computing device 400 can use the audio output component 408 to generate an audio output (e.g., a synthetic voice) that provides output including one or more audible indications of the content associated with the interface element 420 and/or the interface element 422. For example, the audio output component 408 can generate one or more audible indications indicating “TO TRAVEL TO ADA'S SUPERMARKET NOW, SAY ‘TRAVEL TO ADA'S LATER’ TO TRAVEL TO ADA'S SUPERMARKET AT A LATER TIME, SAY ‘ALTERNATIVE LOCATION’ TO TRAVEL TO AN ALTERNATIVE GROCERY STORE, OR SAY, ‘ALTERNATIVE LOCATION LATER’ TO TRAVEL TO AN ALTERNATIVE GROCERY STORE AT A LATER TIME.” The user can provide their response to the computing device 400 via one or more inputs to the audio input component 406 (e.g., a microphone) which can be configured to detect a user's voice. The computing device 400 can then perform one or more voice recognition operations to determine the user's selected course of action based on what the user says in response to the one or more audible indications.

In some embodiments, the computing device 400 can determine a user's selected course of action based at least in part on use of the imaging component 404 (e.g., a camera). For example, the audio output component 408 can generate one or more audible indications indicating “HOLD UP ONE FINGER TO TRAVEL TO ADA'S SUPERMARKET NOW, HOLD UP TWO FINGERS TO TRAVEL TO ADA'S SUPERMARKET AT A LATER TIME, HOLD UP THREE FINGERS TO TRAVEL TO AN ALTERNATIVE GROCERY STORE, OR HOLD UP FOUR FINGERS TO TRAVEL TO AN ALTERNATIVE GROCERY STORE AT A LATER TIME.” The user can then provide their response to the computing device 400 via one or more inputs to the imaging component 404 (e.g., a camera) which can be configured to detect the number of fingers that the user is presenting to the imaging component 404.

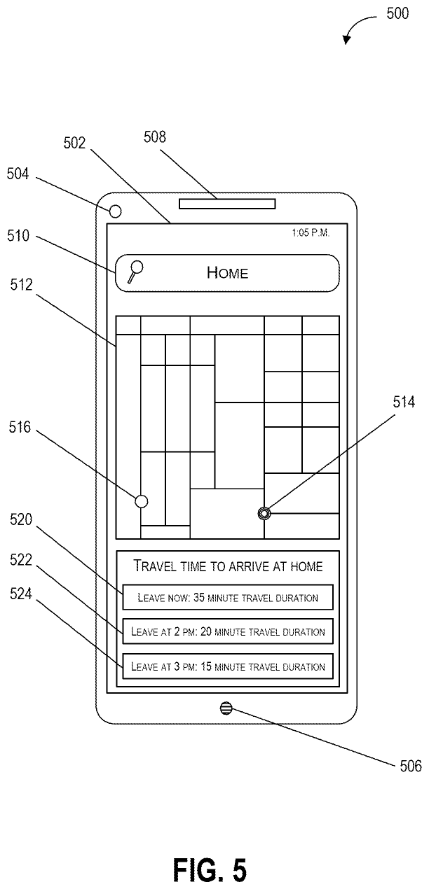

FIG. 5 depicts an example of a navigation system according to example embodiments of the present disclosure. A computing device 500 can include one or more attributes and/or capabilities of the computing device 102, the computing system 130, the training computing system 150, and/or the computing device 300. Furthermore, the computing device 500 can perform one or more actions and/or operations including the one or more actions and/or operations performed by the computing device 102, the computing system 130, the training computing system 150, and/or the computing device 300.

As shown in FIG. 5, the computing device 500 includes a display component 502, an imaging component 504, an audio input component 506, an audio output component 508, an interface element 510, an interface element 512, an interface element 514, an interface element 516, an interface element 520, an interface element 522, and an interface element 524.

The computing device 500 can be configured to perform one or more operations including accessing, processing, sending, receiving, and/or generating data including navigation data, event data, and/or traffic data, any of which can include information associated with one or more locations, one or more maps of one or more geographic areas, a calendar or schedule of a user. Further, the computing device 500 can receive one or more inputs including one or more user inputs from a user of the computing device 500. For example, a user can select a location (e.g., a destination the user may travel to) by selecting the interface element 510 which is displayed on the display component 502 that also shows the interface element 514 which indicates the current location of the computing device 500.

In this example, a user has opened a navigation application on the computing device 500 and is searching for a supermarket nearby. The user has entered the search term “HOME” in the interface element 510 which is used to receive user inputs associated with a search for a location in a geographic area and is configured to receive one or more inputs including touch inputs (e.g., the user touching characters on a pop-up keyboard and spelling out the name of a location to travel to) and/or audible inputs (e.g., the user speaking the search term). In some embodiments, the search term entered into the interface element 510 can include a non-location that is then associated by the computing device 500 with a location.

The computing device 500 can determine the location of “HOME” at the interface element 510 that is indicated on the interface element 512 (e.g., a map of the geographic area within a predetermined distance of the computing device 500) which also includes the interface element 514 that indicates the current location of the computing device 500. Additionally, the computing device 500 can determine that the search term “HOME” indicates a specific location because HOME indicates the location of the home of the user of the computing device 500, which is a specific location that does not have an alternative (e.g., the user owns and lives in only one home).

In some embodiments, the computing device 500 can determine one or more travel times at which the user can travel to the user's HOME location. The one or more travel times can include a travel time if the user travels to the HOME location immediately or nearly immediately (e.g., within a predefined time interval such as one (1) minute). Further, the computing device 500 can determine one or more travel times that occur later in the day when the duration of the trip may be shorter than if the user travels to HOME immediately. By way of example, the computing device 500 can generate the interface element 520 which indicates “LEAVE NOW: 35 MINUTE TRAVEL TIME” and can generate a route to the user's HOME location if the user provides one or more inputs to the interface element 520 (e.g., the user touching the interface element 520 with their finger). The travel time indicated in the interface element 520 is an estimate of the time it will take for the user to travel from the user's current location (indicated by the interface element 514) to the HOME location. The estimated travel time can be determined by the computing device 500 and can be based at least in part on traffic patterns and/or an amount of road traffic in the geographic area including the user's HOME.

Further, the computing device 500 can generate the interface element 522 which indicates “LEAVE AT 2 PM: 20 MINUTE TRAVEL TIME” and can generate a route to the user's HOME location, leaving at two (2) p.m., if the user provides one or more inputs to the interface element 522 (e.g., the user touching the interface element 522 with their finger). Further, the computing device 500 can generate the interface element 524 which indicates “LEAVE AT 3 PM: 15 MINUTE TRAVEL TIME” and can generate a route to the user's HOME location, leaving at three (3) p.m., if the user provides one or more inputs to the interface element 524 (e.g., the user touching the interface element 524 with their finger). Depending on the travel time selected by the user (e.g., travel now, travel at two (2) p.m., or travel at three (3) p.m.) the travel duration will vary. In this way the user can select from a set of flexible travel times (e.g., departure times) and may reduce their travel duration depending on the selected travel time.

In some embodiments, the computing device 500 can use the audio output component 508 to generate an audio output (e.g., a synthetic voice) that provides output including one or more audible indications of the content associated with the interface element 520 and/or the interface element 522. For example, the audio output component 508 can generate one or more audible indications indicating “TO TRAVEL HOME IMMEDIATELY, SAY ‘TRAVEL HOME NOW,’ TO TRAVEL TO HOME AT TWO O'CLOCK, SAY ‘TRAVEL HOME AT TWO,’ TO TRAVEL HOME AT THREE O'CLOCK, SAY ‘TRAVEL HOME AT THREE.” The user can provide their response to the computing device 500 via one or more inputs to the audio input component 506 (e.g., a microphone) which can be configured detect a user's voice. The computing device 500 can then perform one or more voice recognition operations to determine the user's selected course of action based on what the user says in response to the one or more audible indications. In some embodiments, the computing device 500 can receive one or more inputs (e.g., one or more audio inputs and/or one or more tactile inputs) from the user including one or more user indications that include a relative term (e.g., “earlier,” “later,” “sooner”). Further, the computing device 500 can receive one or more inputs from the user including the indications “earlier” or “later” to indicate that the user would respectively prefer to travel at an earlier time or a later time. For example, if the user indicates “I'D LIKE TO GET HOME EARLIER” and the computing device 500 could perform one or more voice recognition operations to determine that the provided travel times included in the output will be at an earlier portion of the time window of travel times provided to the user. By way of further example, if the user indicates “I'D LIKE TO GET HOME LATER” and the computing device 500 could perform one or more voice recognition operations to determine that the provided travel times included in the output will be at a later portion of the time window of travel times provided to the user.

In some embodiments, the computing device 500 can determine a user's selected course of action based at least in part on use of the imaging component 504 (e.g., a camera). For example, the audio output component 508 can generate one or more audible indications indicating “HOLD UP ONE FINGER TO TRAVEL HOME NOW, HOLD UP TWO FINGERS TO GO HOME AT TWO O'CLOCK, HOLD UP THREE FINGERS TO GO HOME AT THREE O'CLOCK.” The user can then provide their response to the computing device 500 via one or more inputs to the imaging component 504 (e.g., a camera) which can be configured to detect the number of fingers that the user is presenting to the imaging component 504.

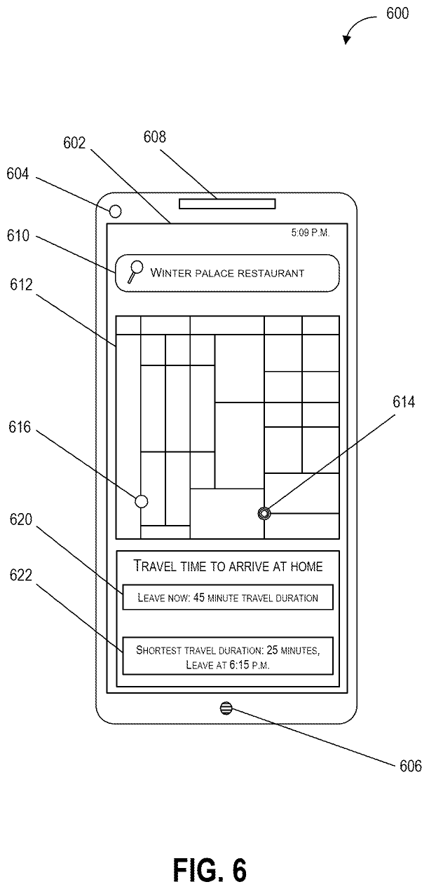

FIG. 6 depicts an example of a navigation system according to example embodiments of the present disclosure. A computing device 600 can include one or more attributes and/or capabilities of the computing device 102, the computing system 130, the training computing system 150, and/or the computing device 300. Furthermore, the computing device 600 can perform one or more actions and/or operations including the one or more actions and/or operations performed by the computing device 102, the computing system 130, the training computing system 150, and/or the computing device 300.

As shown in FIG. 6, the computing device 600 includes a display component 602, an imaging component 604, an audio input component 606, an audio output component 608, an interface element 610, an interface element 612, an interface element 614, an interface element 616, an interface element 618, an interface element 620, and an interface element 622.

The computing device 600 can be configured to perform one or more operations including accessing, processing, sending, receiving, and/or generating data including navigation data, event data, and/or traffic data, any of which can include information associated with one or more locations, one or more maps of one or more geographic areas, a calendar or schedule of a user. Further, the computing device 600 can receive one or more inputs including one or more user inputs from a user of the computing device 600. For example, a user can select a location (e.g., a destination the user may travel to) by selecting the interface element 610 which is displayed on the display component 602 that also shows the interface element 614 which indicates the location of the computing device 600.

In this example, a user has opened a navigation application on the computing device 600 and is searching for a supermarket nearby. The user has entered the search term “WINTER PALACE RESTAURANT” in the interface element 610 which is used to receive user inputs associated with a search for a location in a geographic area and is configured to receive one or more inputs including touch inputs (e.g., the user touching characters on a pop-up keyboard and spelling out the name of a location to travel to) and/or audible inputs (e.g., the user speaking the search term).

The computing device 600 can determine the location of “WINTER PALACE RESTAURANT” at the interface element 616 indicated on the interface element 612 (e.g., a map of the geographic area within a predetermined distance of the computing device 600) which also includes the interface element 614 that indicates the current location of the computing device 600. Additionally, the computing device 600 can determine that the search term “WINTER PALACE RESTAURANT” indicates a specific location because WINTER PALACE RESTAURANT is a unique restaurant.

In some embodiments, the computing device 600 can determine one or more travel times that the user can travel to the WINTER PALACE RESTAURANT location. The one or more travel times can include a travel time if the user travels to WINTER PALACE RESTAURANT immediately or nearly immediately (e.g., within a predefined time interval such as two (2) minutes). Further, the computing device 600 can determine one or more travel times that occur later in the day when the duration of the trip may be shorter than if the user travels to WINTER PALACE RESTAURANT immediately. By way of example, the computing device 600 can generate the interface element 620 which indicates “LEAVE NOW: 45 MINUTE TRAVEL DURATION” and can generate a route to WINTER PALACE RESTAURANT if the user provides one or more inputs to the interface element 620 (e.g., the user touching the interface element 620 with their finger). Further, the computing device 600 can determine the travel time at which travel duration is the shortest and generate the interface element 622 which indicates “SHORTEST TRAVEL DURATION: 25 MINUTES, LEAVE AT 6:15 P.M.” Further, the computing device 600 can generate a route to the WINTER PALACE RESTAURANT if the user provides one or more inputs to the interface element 622 (e.g., the user touching the interface element 622 with their finger).

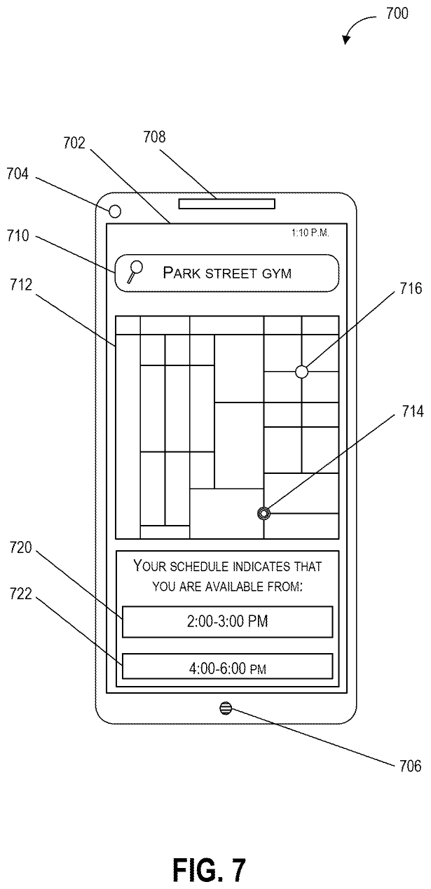

FIG. 7 depicts an example of a navigation system according to example embodiments of the present disclosure. A computing device 700 can include one or more attributes and/or capabilities of the computing device 102, the computing system 130, the training computing system 150, and/or the computing device 300. Furthermore, the computing device 700 can perform one or more actions and/or operations including the one or more actions and/or operations performed by the computing device 102, the computing system 130, the training computing system 150, and/or the computing device 300.

As shown in FIG. 7, the computing device 700 includes a display component 702, an imaging component 704, an audio input component 706, an audio output component 708, an interface element 710, an interface element 712, an interface element 714, an interface element 716, an interface element 718, an interface element 720, and an interface element 722.

The computing device 700 can be configured to perform one or more operations including accessing, processing, sending, receiving, and/or generating data including navigation data, event data, and/or traffic data, any of which can include information associated with one or more locations, one or more maps of one or more geographic areas, a calendar or schedule of a user. Further, the computing device 700 can receive one or more inputs including one or more user inputs from a user of the computing device 700. For example, a user can select a location (e.g., a destination the user may travel to) by selecting the interface element 710 which is displayed on the display component 702 that also shows the interface element 714 which indicates the location of the computing device 700.

In this example, a user has opened a navigation application on the computing device 700 and is searching for a supermarket nearby. The user has entered the search term “PARK STREET GYM” in the interface element 710. The interface element 710 is used to receive user inputs associated with a search for a location in a geographic area and is configured to receive one or more inputs including touch inputs (e.g., the user touching characters on a pop-up keyboard and spelling out the name of a location to travel to) and/or audible inputs (e.g., the user speaking the search term).

The computing device 700 can determine the location of “PARK STREET GYM” at the interface element 710 that is indicated on the interface element 712 (e.g., a map of the geographic area within a predetermined distance of the computing device 700) which also includes the interface element 714 that indicates the current location of the computing device 700. Additionally, the computing device 700 can determine that the search term “PARK STREET GYM” indicates a specific location since there are not any other location named the PARK STREET GYM within a one-hundred (100) kilometer radius of the computing device 700.

In some embodiments, the computing device 700 can determine one or more travel times that the user can travel to PARK STREET GYM. The one or more travel times can be based at least in part on event data that indicates the user's availability (e.g., a calendar that includes the user's schedule for that day). In this example, the computing device 700 can generate the interface element 720 and the interface element 722 which indicate the times at which the event data for the user indicates that the user is available. The interface element 720 indicates that the user is available from “2:00-3:00 P.M.” and can generate a route to PARK STREET GYM that will begin at 2:00 P.M. if the user provides one or more inputs to the interface element 720 (e.g., the user touching the interface element 720 with their finger). Further, the interface element 722 indicates that the user is available from “2:00-3:00 P.M.” and can generate a route to PARK STREET GYM that will begin at 4:00 P.M. if the user provides one or more inputs to the interface element 722 (e.g., the user touching the interface element 722 with their finger). In some embodiments, the route to the location can be generated at any time during the time period of availability (e.g., the computing device 700 can generate a route to travel at some time between 2:00-3:00 PM if the user touches the interface element 720).

In some embodiments, the computing device 700 can use the audio output component 708 to generate an audio output (e.g., a synthetic voice) that provides output including one or more audible indications of the content associated with the interface element 720 and/or the interface element 722. For example, the audio output component 708 can generate one or more audible indications indicating “TO TRAVEL TO THE PARK STREET GYM BETWEEN TWO AND THREE O'CLOCK, SAY ‘TRAVEL AT TWO,’ TO TRAVEL TO THE PARK STREET GYM BETWEEN FOUR AND SIX O'CLOCK, SAY ‘TRAVEL AT FOUR’.” The user can provide their response to the computing device 700 via one or more inputs to the audio input component 706 (e.g., a microphone) which can be configured detect a user's voice. The computing device 700 can then perform one or more voice recognition operations to determine the user's selected course of action based on what the user says in response to the one or more audible indications.

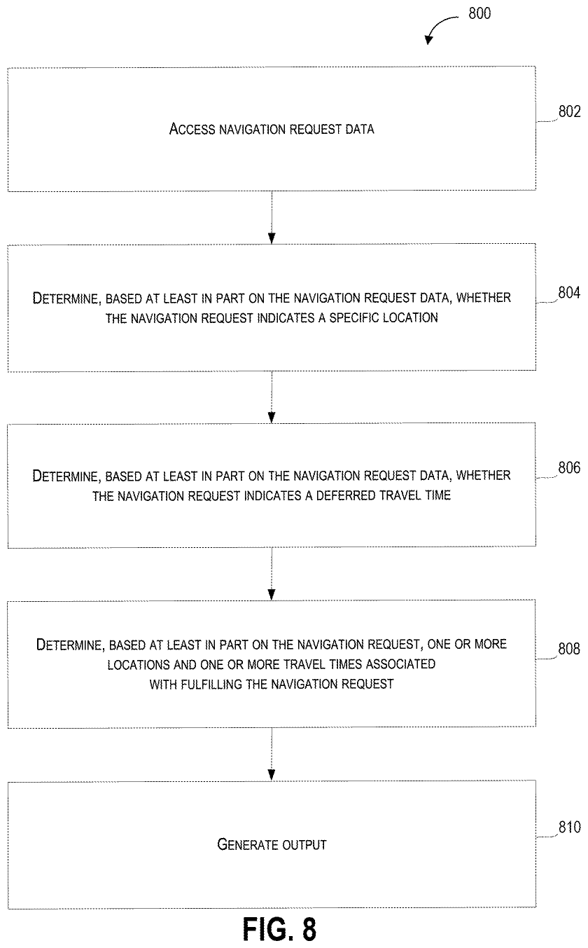

FIG. 8 depicts a flow diagram of flexible navigation according to example embodiments of the present disclosure. One or more portions of the method 800 can be executed and/or implemented on one or more computing devices or computing systems including, for example, the computing device 102, the computing system 130, the training computing system 150, and/or the computing device 300. Further, one or more portions of the method 800 can be executed or implemented as an algorithm on the hardware devices or systems disclosed herein. In some embodiments, one or more portions of the method 800 can be performed as part of the method 800 that is depicted in FIG. 8. FIG. 8 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 802, the method 800 can include accessing navigation data comprising information associated with a navigation request from a user. For example, the computing device 102 can access locally stored navigation data that includes information associated with the current location (latitude, longitude, and/or altitude) of the computing device 102 and a location that the user has indicated as a travel destination. In some embodiments, one or more portions of the navigation data can be stored remotely (e.g., on the computing system 130) and the computing device 102 can access the one or more portions of navigation data based at least in part on the navigation data included in the navigation data.

At 804, the method 800 can include determining, based at least in part on the navigation data, whether the navigation request indicates a specific location. For example, the computing device 102 can use the navigation data as part of an input to one or more machine-learned models that are configured and/or trained to access the input, perform one or more operations on the input, and generate an output including a determination of whether the navigation request indicates a specific location (e.g., whether the navigation request indicates “TRAVEL HOME” which is a specific location) or “TRAVEL TO A GROCERY STORE” which is not a specific location).

At 806, the method 800 can include determining, based at least in part on the navigation data, whether the navigation request indicates a deferred travel time. For example, the computing device 102 can use the navigation data as part of an input to one or more machine-learned models that are configured and/or trained to access the input, perform one or more operations on the input, and generate an output including a determination of whether the navigation request indicates a deferred travel time (e.g., whether the navigation request indicates “RESTAURANT RIGHT NOW” which is a deferred travel time or “RESTAURANT FOR LATER” which is not a deferred travel time).

At 808, the method 800 can include determining, based at least in part on the navigation data, one or more locations and one or more travel times associated with fulfilling the navigation request. The one or more locations can be based at least in part on whether the navigation request indicates a specific location. Further, the one or more travel times can be based at least in part on whether the navigation request indicates a deferred travel time. For example, the computing device 102 can determine the one or more locations and/or one or more travel times that are within the constraints of the location and/or travel time indicated in the navigation request.

At 810, the method 800 can include generating output comprising one or more indications associated with a time window of the one or more travel times for the user to travel to at least one of the one or more locations. For example, the computing device 102 can include a display component that is used to display the one or more indications associated with navigation by the user to at least one of the one or more locations during a time window comprising at least one of the one or more travel times. By way of further example, the computing device 102 can include an audio output component that is used to announce the one or more indications associated with navigation by the user. If the one or more indications are associated with restaurants, the one or more indications can indicate the respective names of the restaurants, the respective travel times to the restaurants, and/or the respective distances to the restaurants.

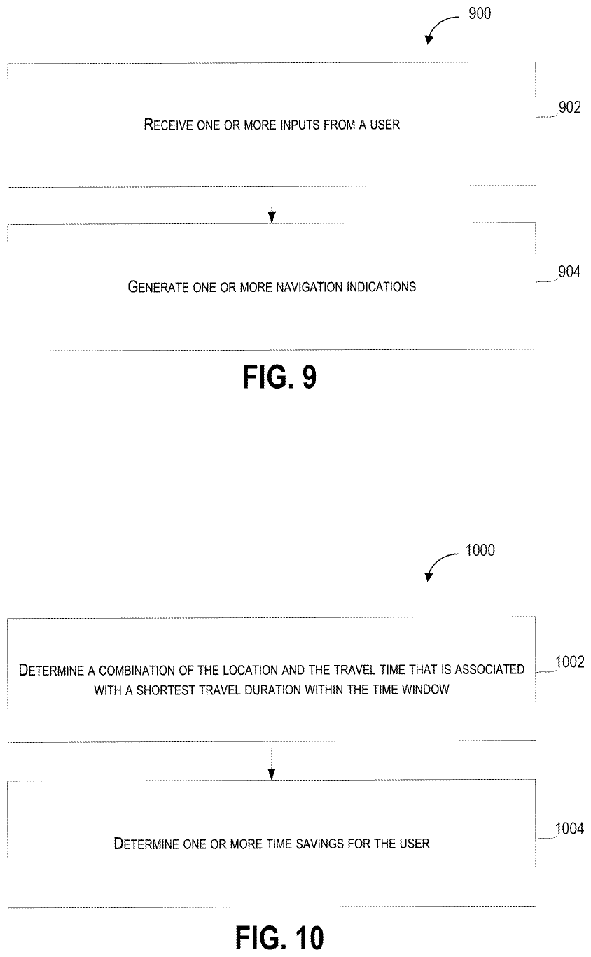

FIG. 9 depicts a flow diagram of flexible navigation according to example embodiments of the present disclosure. One or more portions of the method 900 can be executed and/or implemented on one or more computing devices or computing systems including, for example, the computing device 102, the computing system 130, the training computing system 150, and/or the computing device 300. Further, one or more portions of the method 900 can be executed or implemented as an algorithm on the hardware devices or systems disclosed herein. In some embodiments, one or more portions of the method 900 can be performed as part of the method 800 that is depicted in FIG. 8. FIG. 9 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 902, the method 900 can include receiving one or more inputs from a user. The one or more inputs can include a user selected location and a user selected time range. Further, the user selected location can be selected from the one or more locations and the user selected time range can be selected from the one or more travel times. For example, the output generated by the computing device 102 can include one or more locations and one or more travel times displayed on a display output device. The user can select the user selected location and user selected time range by speaking to a microphone that is configured to recognize the user's speech.

At 904, the method 900 can include generating one or more navigation indications that include a route from a current location of the user to the user selected location within the user selected time range. For example, the computing device 102 can use the user selected location to determine the one or more routes (e.g., roads that the user can travel) between the current location of the user and the user selected location within the user selected time range (e.g., the next hour).

FIG. 10 depicts a flow diagram of flexible navigation according to example embodiments of the present disclosure. One or more portions of the method 1000 can be executed and/or implemented on one or more computing devices or computing systems including, for example, the computing device 102, the computing system 130, the training computing system 150, and/or the computing device 300. Further, one or more portions of the method 1000 can be executed or implemented as an algorithm on the hardware devices or systems disclosed herein. In some embodiments, one or more portions of the method 1000 can be performed as part of the method 800 that is depicted in FIG. 8. FIG. 10 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1002, the method 1000 can include determining a combination of the location of the one or more locations and the travel time of the one or more travel times that is associated with a shortest travel duration within the time window of the one or more travel times. The output can include the combination of the location and the travel time that is associated with the shortest travel duration. For example, the computing system 130 can generate one or more routes from the current location and the one or more locations at each of the one or more travel times and then determine the shortest travel duration of each of the one or more routes.

At 1004, the method 1000 can include determining one or more time savings for the user based at least in part on one or more differences in travel duration between the user travelling to the one or more locations immediately and the user travelling to the one or more locations at the one or more travel times. The output can include the one or more time savings. For example, the computing system 130 can determine the one or more time savings the user can benefit from by travelling to a location at a later time instead of immediately.

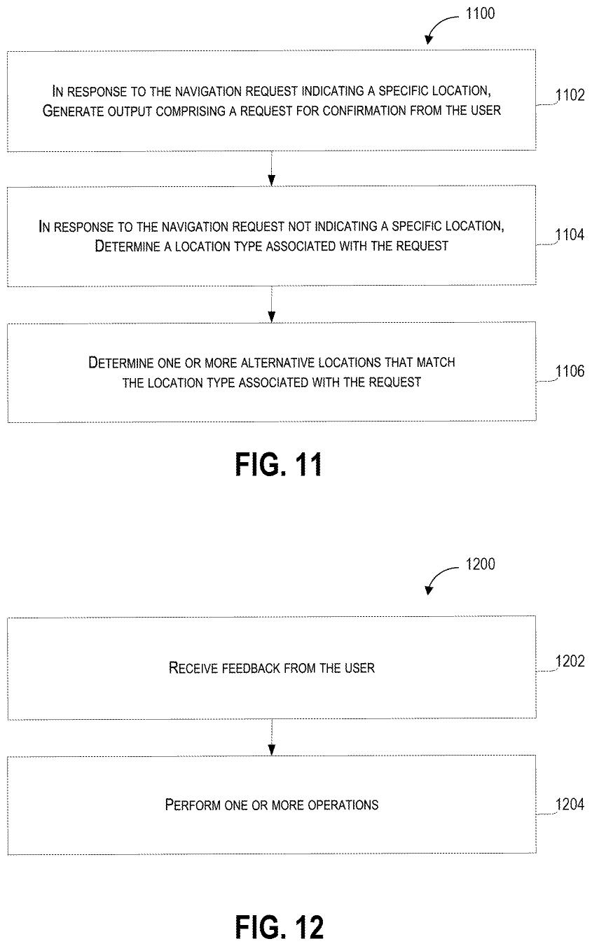

FIG. 11 depicts a flow diagram of flexible navigation according to example embodiments of the present disclosure. One or more portions of the method 1100 can be executed and/or implemented on one or more computing devices or computing systems including, for example, the computing device 102, the computing system 130, the training computing system 150, and/or the computing device 300. Further, one or more portions of the method 1100 can be executed or implemented as an algorithm on the hardware devices or systems disclosed herein. In some embodiments, one or more portions of the method 1100 can be performed as part of the method 800 that is depicted in FIG. 8. FIG. 11 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1102, the method 1100 can include in response to the navigation request indicating a specific location, generating output including a request for confirmation from the user that the user indicated a specific location. For example, the computing device 102 can generate one or more audible indications to confirm that the user indicated a specific location (e.g., a particular department store) and not a general location (e.g., any department store) that could fulfill the navigation request.

At 1104, the method 1100 can include in response to the navigation request not indicating a specific location, determining a location type associated with the navigation request. For example, if the computing device 102 determines that the navigation request does not indicate a specific location, the computing device 102 can use one or more machine-learned models to determine the location type (e.g., restaurant, department store, supermarket) associated with the navigation request.

At 1106, the method 1100 can include determining that the location type of the one or more locations matches the location type associated with the navigation request. For example, if the computing device 102 determined that the location type is a restaurant, the one or more locations would include only restaurants and/or other eating establishments.

FIG. 12 depicts a flow diagram of flexible navigation according to example embodiments of the present disclosure. One or more portions of the method 1200 can be executed and/or implemented on one or more computing devices or computing systems including, for example, the computing device 102, the computing system 130, the training computing system 150, and/or the computing device 300. Further, one or more portions of the method 1200 can be executed or implemented as an algorithm on the hardware devices or systems disclosed herein. In some embodiments, one or more portions of the method 1200 can be performed as part of the method 800 that is depicted in FIG. 8. FIG. 12 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1202, the method 1200 can include receiving feedback from the user. The feedback can be received and/or accessed via a user interface (e.g., a graphical user interface configured to receive tactile input from a user and/or a user interface that is configured to receive audible input from a user). The feedback from the user can be in response to output from the computing device 102 that requests feedback from the user with respect to whether the user would prefer to defer navigation.

At 1204, the method 1200 can include performing one or more operations, based at least in part on the feedback from the user. The one or more operations can include modifying one or more heuristics associated with determining whether the navigation request specifies a specific location or a deferred travel time to travel to the location, and/or training one or more machine-learned models that are configured to determine whether the navigation request specifies a specific location and/or a deferred travel time to travel to the location. For example, in response to the computing device 102 receiving feedback indicating that the user would like to defer navigation, the computing device 102 can adjust the weighting of one or more parameters of one or more machine-learned models to reflect that the context (e.g., time of day and/or location of the computing device 102) is associated with the user deferring navigation.

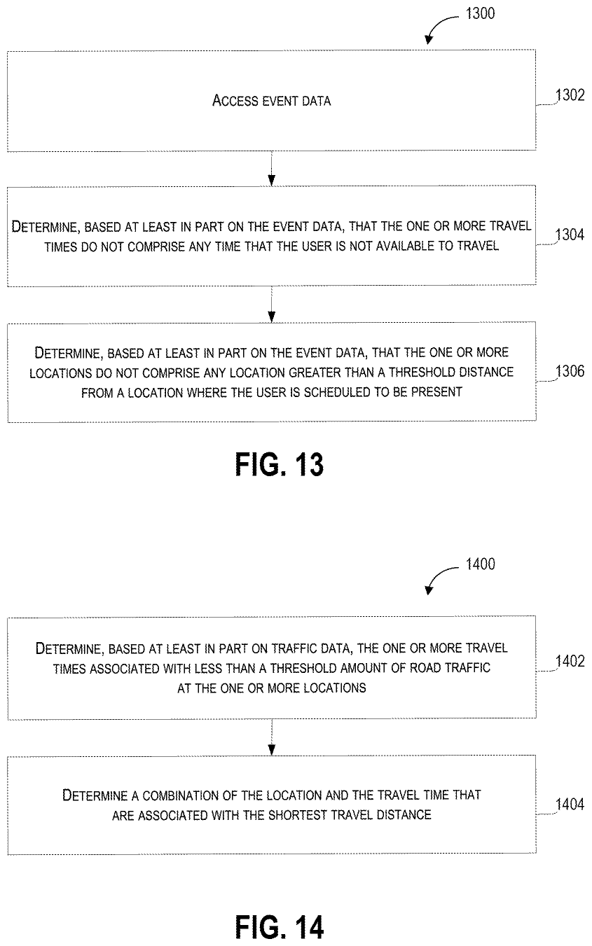

FIG. 13 depicts a flow diagram of flexible navigation according to example embodiments of the present disclosure. One or more portions of the method 1300 can be executed and/or implemented on one or more computing devices or computing systems including, for example, the computing device 102, the computing system 130, the training computing system 150, and/or the computing device 300. Further, one or more portions of the method 1300 can be executed or implemented as an algorithm on the hardware devices or systems disclosed herein. In some embodiments, one or more portions of the method 1300 can be performed as part of the method 800 that is depicted in FIG. 8. FIG. 13 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1302, the method 1300 can include accessing event data that includes information associated with a schedule of the user and/or travel history of the user. For example, the computing device 102 can access locally stored event data that includes the times during a day during which the user is engaged in various activities.

At 1304, the method 1300 can include determining, based at least in part on the event data, that the one or more travel times do not include any time that the user is not available to travel. For example, the computing device 102 can use the event data to compare the one or more travel times to the one or more times during which the user is engaged in some activity and thereby determine when the user is not available to travel.

At 1306, the method 1300 can include determining, based at least in part on the event data, that the one or more locations do not include any location that is greater than a threshold distance away from a location where the user is scheduled to be present during the one or more travel times. For example, the computing device 102 can determine that the one or more locations will not include any location that is greater than one-hundred (100) meters from a location where the user is scheduled to be present during the one or more travel times.

FIG. 14 depicts a flow diagram of flexible navigation according to example embodiments of the present disclosure. One or more portions of the method 1400 can be executed and/or implemented on one or more computing devices or computing systems including, for example, the computing device 102, the computing system 130, the training computing system 150, and/or the computing device 300. Further, one or more portions of the method 1400 can be executed or implemented as an algorithm on the hardware devices or systems disclosed herein. In some embodiments, one or more portions of the method 1400 can be performed as part of the method 800 that is depicted in FIG. 8. FIG. 14 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1402, the method 1400 can include determining, based at least in part on traffic data, the one or more travel times associated with less than a threshold amount of road traffic at the one or more locations. For example, the computing device 102 can access real-time traffic data stored on the computing system 130 and determine the one or more travel times associated with a threshold amount of road traffic for each of the one or more travel times.

At 1404, the method 1400 can include determining a combination of the location of the one or more locations and the travel time of the one or more travel times that are associated with a shortest travel distance. For example, the computing device 102 can use the distance of the one or more locations from the current location of the computing device 102 to determine a location and travel time that are associated with the shortest travel distance. The shortest travel distance can be based at least in part on the current location of the computing device 102 (e.g., if the user will travel immediately) or a predicted location of the computing device 102 (e.g., if the user will travel at a later time).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method of navigation, the computer-implemented method comprising:
accessing, by a computing system comprising one or more processors, navigation data comprising information associated with a navigation request from a user;
determining, by the computing system, based at least in part on the navigation data, whether the navigation request indicates a specific location;
determining, by the computing system, based at least in part on the navigation data, whether the navigation request indicates a deferred travel time;
determining, by the computing system, based at least in part on the navigation data, one or more locations and one or more travel times associated with fulfilling the navigation request, wherein the one or more locations are determined based at least in part on whether the navigation request indicates a specific location, and wherein the one or more travel times comprise one or more deferred travel times and are determined based at least in part on whether the navigation request indicates a deferred travel time; and
generating, by the computing system, output comprising one or more indications associated with navigation by the user to at least one of the one or more locations during a time window comprising at least one of the one or more travel times.

2. The computer-implemented method of claim 1, further comprising:
receiving, by the computing system, one or more inputs from the user, wherein the one or more inputs comprise a user selected location and a user selected time range, wherein the user selected location is selected from the one or more locations, and wherein the user selected time range is selected from the one or more travel times; and
generating, by the computing system, one or more navigation indications comprising a route from a current location of the user to the user selected location within the user selected time range.

3. The computer-implemented method of claim 1, further comprising:
determining, by the computing system, a combination of the location of the one or more locations and the travel time of the one or more travel times that is associated with a shortest travel duration within the time window of the one or more travel times, wherein the output comprises the combination of the location and the travel time that is associated with the shortest travel duration.

4. The computer-implemented method of claim 1, further comprising:
determining, by the computing system, one or more time savings for the user based at least in part on one or more differences in travel duration between the user travelling to the one or more locations immediately and the user travelling to the one or more locations at the one or more travel times, wherein the output comprises the one or more time savings.

5. The computer-implemented method of claim 1, further comprising:
in response to the navigation request indicating a specific location, generating, by the computing system, output comprising a request for confirmation from the user that the user indicated a specific location; or
in response to the navigation request not indicating a specific location, determining, by the computing system, a location type associated with the navigation request; and
determining, by the computing system, one or more alternative locations that match the location type associated with the navigation request, wherein the output comprises the one or more alternative locations.

6. The computer-implemented method of claim 1, wherein the output comprises a request for feedback from the user with respect to whether the user prefers to defer navigation, and further comprising:
receiving, by the computing system, the feedback from the user; and
performing, by the computing system, one or more operations based at least in part on the feedback from the user, wherein the one or more operations comprise modifying one or more heuristics associated with determining whether the navigation request specifies a specific location or a deferred travel time to travel to the location, or training one or more machine-learned models that are configured to determine whether the navigation request specifies a specific location or a deferred travel time to travel to the location.

7. The computer-implemented method of claim 6, wherein the output comprises a request for feedback from the user with respect to the one or more locations or the one or more travel times, and wherein the one or more operations comprise modifying one or more heuristics associated with determining whether the navigation request specifies a specific location or a deferred travel time to travel to the location, or training one or more machine-learned models that are configured to determine whether the navigation request specifies a specific location or a deferred travel time to travel to the location.

8. The computer-implemented method of claim 1, further comprising:
accessing, by the computing system, event data comprising information associated with a schedule of the user or travel history of the user; and
determining, by the computing system, based at least in part on the event data, that the one or more travel times do not comprise any time that the user is not available to travel.

9. The computer-implemented method of claim 8, further comprising:
determining, by the computing system, based at least in part on the event data, that the one or more locations do not comprise any location greater than a threshold distance from a location where the user is scheduled to be present during the one or more travel times.

10. The computer-implemented method of claim 8, wherein the output comprises a notification that is generated within a predetermined amount of time of the earliest travel time of the one or more travel times that the user is available to travel.

11. The computer-implemented method of claim 1, further comprising:
determining, by the computing system, based at least in part on traffic data, the one or more travel times associated with less than a threshold amount of road traffic at the one or more locations, wherein the traffic data comprises information associated with road traffic in a geographic region associated with the navigation request, and wherein the output comprises the one or more travel times associated with less than the threshold amount of road traffic at the one or more locations.

12. The computer-implemented method of claim 1, further comprising:
determining, by the computing system, a combination of the location of the one or more locations and the travel time of the one or more travel times that are associated with a shortest travel distance, wherein the output comprises the combination of the location and the travel time that is associated with the shortest travel distance.

13. The computer-implemented method of claim 1, wherein whether the navigation request indicates a specific location or a deferred travel time is based at least in part on use of one or more machine-learned models configured to determine whether the navigation request specifies a specific location based at least in part on an input comprising the navigation request.

14. The computer-implemented method of claim 13, wherein the input comprises one or more audible inputs associated with the navigation request, and wherein the one or more machine-learned models are configured to determine whether the navigation request specifies a specific location or a deferred travel time to travel to the location based at least in part on an application of one or more natural language processing techniques.

15. One or more tangible non-transitory computer-readable media storing computer-readable instructions that when executed by one or more processors cause the one or more processors to perform operations, the operations comprising:
accessing navigation data comprising information associated with a navigation request from a user;
determining, based at least in part on the navigation data, whether the navigation request indicates a specific location;
determining, based at least in part on the navigation data, whether the navigation request indicates a deferred travel time;
determining, based at least in part on the navigation data, one or more locations and one or more travel times associated with fulfilling the navigation request, wherein the one or more locations are determined based at least in part on whether the navigation request indicates a specific location, and wherein the one or more travel times comprise one or more deferred travel times and are determined based at least in part on whether the navigation request indicates a deferred travel time; and
generating output comprising one or more indications associated with navigation by the user to at least one of the one or more locations during a time window comprising at least one of the one or more travel times.

16. The one or more tangible non-transitory computer-readable media of claim 15, wherein the output comprises one or more visual indications, and wherein the one or more visual indications are presented on a map of a geographic area comprising a portion of the one or more locations.

17. The one or more tangible non-transitory computer-readable media of claim 15, wherein the output comprises one or more audible indications, and wherein the one or more audible indications indicate the time window of the one or more travel times for the user to travel to at least one of the one or more locations.

18. A computing system comprising:
one or more processors;
one or more non-transitory computer-readable media storing instructions that when executed by the one or more processors cause the one or more processors to perform operations comprising:
accessing navigation data comprising information associated with a navigation request from a user;
determining, based at least in part on the navigation data, whether the navigation request indicates a specific location;
determining, based at least in part on the navigation data, whether the navigation request indicates a deferred travel time;
determining, based at least in part on the navigation data, one or more locations and one or more travel times associated with fulfilling the navigation request, wherein the one or more locations are determined based at least in part on whether the navigation request indicates a specific location, and wherein the one or more travel times comprise one or more deferred travel times and are determined based at least in part on whether the navigation request indicates a deferred travel time; and
generating output comprising one or more indications associated with navigation by the user to at least one of the one or more locations during a time window comprising at least one of the one or more travel times.

19. The computing system of claim 18, wherein the output comprises one or more turn-by-turn directions for navigation to the one or more locations.

20. The computing system of claim 18, wherein the navigation request is based at least in part on one or more interactions of the user, and wherein the one or more interactions comprise one or more tactile inputs to a graphical user interface of a navigation application, one or more textual inputs to the navigation application, or one or more spoken statements by the user.
